(19) United States
(12) Patent Application Publication
(10) Pub. No.: US 2018/0165698 A1
(43) Pub. Date: Jun. 14, 2018

(54) METHODS AND SYSTEMS TO DETERMINE VIRTUAL STORAGE COSTS OF A VIRTUAL DATACENTER

(71) Applicant: VMWARE, INC., Palo Alto, CA (US)

(72) Inventors: SHRISHA CHANDRASHEKAR, Bangalore (IN); MRITYUNJOY SAHA, Bangalore (IN); VIJAY POTLURI, Bangalore (IN); AMARNATH PALAVALLI, Seattle, WA (US); KUMAR GAURAV, Bangalore (IN)

(21) Appl. No.: 15/427,072

(22) Filed: Feb. 8, 2017

(30) Foreign Application Priority Data
Dec. 9, 2016 (IN) 201641041650

(51) Int. Cl. G06Q 30/02; G06F 3/06; G06F 9/455

(52) U.S. Cl. CPC G06Q 30/0206; G06F 3/0605; G06F 3/0664; G06F 2009/45583; G06F 3/0685; G06F 9/45558; G06F 3/067

(57) ABSTRACT

Methods and systems that allocate the total cost of virtual storage created from hard disk drives (“HDDs”) and solid state drives (“SSDs”) of server computers and mass-storage devices of a cloud-computing facility are described. The virtual storage is used to form virtual disks (“VDs”) of virtual machines (“VMs”) comprising a virtual datacenter (“VDC”). Methods calculate a total virtual storage cost of the virtual storage from hardware costs and other costs such as labor, maintenance, facilities and licensing costs, which is used to calculate an HDD cost rate and an SSD cost rate. A cost of each VD is calculate based on virtual storage policy parameters, the HDD cost rate, and the SSD cost rate. The costs of the VDs associated with a VM are combined to obtain a VM storage cost. The VM storage costs may be combined to obtain the virtual storage cost of the VDC.

### RELATED APPLICATION

Benefit is claimed under 35 U.S.C. 119(a)-(d) to Foreign Application Serial No. 201641041650 filed in India entitled “METHODS AND SYSTEMS TO DETERMINE VIRTUAL STORAGE COSTS OF A VIRTUAL DATACENTER”, filed on Dec. 6, 2016, by VMware, Inc., which is herein incorporated in its entirety by reference for all purposes.

### TECHNICAL FIELD

This disclosure is directed to methods and systems that determine virtual storage costs of virtual machines that form a virtual datacenter.

### BACKGROUND

In recent years, the computing needs of various organizations have shifted from organization owned and operated computer systems to cloud computing providers. Cloud computing providers charge customers to store and run their applications in a cloud-computing facility and allow customers to purchase computing services in much the same way utility customers purchase a service from a public utility. A typical cloud-computing facility comprises numerous racks of servers, switches, routers, and mass data-storage devices interconnected by local-area networks, wide-area networks, and wireless communications that may be consolidated into a single datacenter or distributed geographically over a number of datacenters. Cloud computing customers typically run their applications in a cloud-computing facility as virtual machines (“VMs”) that may be consolidated into a virtual datacenter (“VDC”) also called a software defined datacenter (“SDDC”). A VDC recreates the architecture and functionality of a physical datacenter for running a customer's applications. However, VMs are not fixed entities. VMs may be migrated between different hosts within a cloud-computing facility in order to improve performance or reduce costs for the customer. VDCs are also scalable in that the number of VMs may be dynamically scaled up or down depending on demand. For example, as demand for a customer's applications increases, additional VMs may be created to handle the increasing demand. On the other hand, the number of VMs may be scaled down as demand for the customer's applications decreases. The VMs may also be reconfigured to handle changing demands, such as changes in the amount of storage and memory associated with each VM. However, because of the dynamic nature of VDCs, information technology (“IT”) managers are faced with numerous management challenges. In particular, IT managers are faced with the challenge of determining costs of maintaining numerous customers' VDCs that are changing.

### SUMMARY

This disclosure is directed to methods and systems that allocate the total cost of virtual storage created from hard disk drives (“HDDs”) and solid state drives (“SSDs”) of server computers and mass-storage devices of a cloud-computing facility. The virtual storage is used to form virtual disks (“VDs”) of virtual machines (“VMs”) comprising a virtual datacenter (“VDC”). A VD is a virtual data-storage device that provides an area of usable storage capacity on one or more HDDs of the server computers and mass-storage devices. Methods calculate a total virtual storage cost of the virtual storage from hardware costs and other costs such as labor, maintenance, facilities and licensing costs. The total virtual storage cost is used to calculate an HDD cost rate and an SSD cost rate. A cost of each VD is calculate based on virtual storage policy parameters, the HDD cost rate, and the SSD cost rate. The costs of the VDs associated with each VM are combined to obtain a VM storage cost for each VM. The VM storage costs may be combined to obtain the virtual storage cost of the VDC.

### DESCRIPTION OF THE DRAWINGS

FIG. 1 shows a general architectural diagram for various types of computers.

FIG. 2 shows an Internet-connected distributed computer system.

FIG. 3 shows cloud computing.

FIG. 4 shows generalized hardware and software components of a general-purpose computer system.

FIGS. 5A-5B show two types of virtual machine and virtual-machine execution environments.

FIG. 6 shows an example of an open virtualization format package.

FIG. 7 shows virtual datacenters provided as an abstraction of underlying physical-data-center hardware components.

FIG. 8 shows virtual-machine components of a virtual-data-center management server and physical servers of a physical datacenter.

FIG. 9 shows a cloud-director level of abstraction.

FIG. 10 shows virtual-cloud-connector nodes.

FIG. 11 shows two ways in which operating-system-level virtualization may be implemented in a physical datacenter.

FIG. 12 shows an example server computer used to host three containers.

FIG. 13 shows an approach to implementing containers on a virtual machine.

FIG. 14 shows an example of a cloud-computing facility.

FIG. 15 shows an example of virtual storage above a virtual interface plane.

FIG. 16 shows an array of virtual machines above the virtual storage and virtual interface plane shown in FIG. 15.

FIG. 17 shows an example of a virtual storage management policy with details presented in the form of a table.

FIG. 18 shows a flow-control diagram of a method to determine virtual storage cost in a virtual data center.

FIG. 19 shows a flow-control diagram of the routine “calculate total virtual storage cost” called in FIG. 18.

FIG. 20 shows a flow-control diagram of the routine “calculate hard disk drive (HDD) cost rate” called in FIG. 18.

FIG. 21 shows a flow-control diagram of the routine “calculate solid state disk (SSD) cost rate” called in FIG. 18.

FIG. 22 shows a flow-control diagram of the routine “calculate cost of each virtual disk (VD) of the virtual disk storage” called in FIG. 18.

FIG. 23 shows a flow-control diagram of the routine “calculate virtual storage cost of each virtual machine (VM)” called in FIG. 18.

### DETAILED DESCRIPTION

This disclosure presents computational methods and systems to determine virtual storage costs of virtual machines that form a virtual datacenter. In a first subsection, computer hardware, complex computational systems, and virtualization are described. Containers and containers supported by virtualization layers are described in a section subsection. Methods and systems to determine virtual storage costs in a virtual datacenter are described below in a third subsection.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

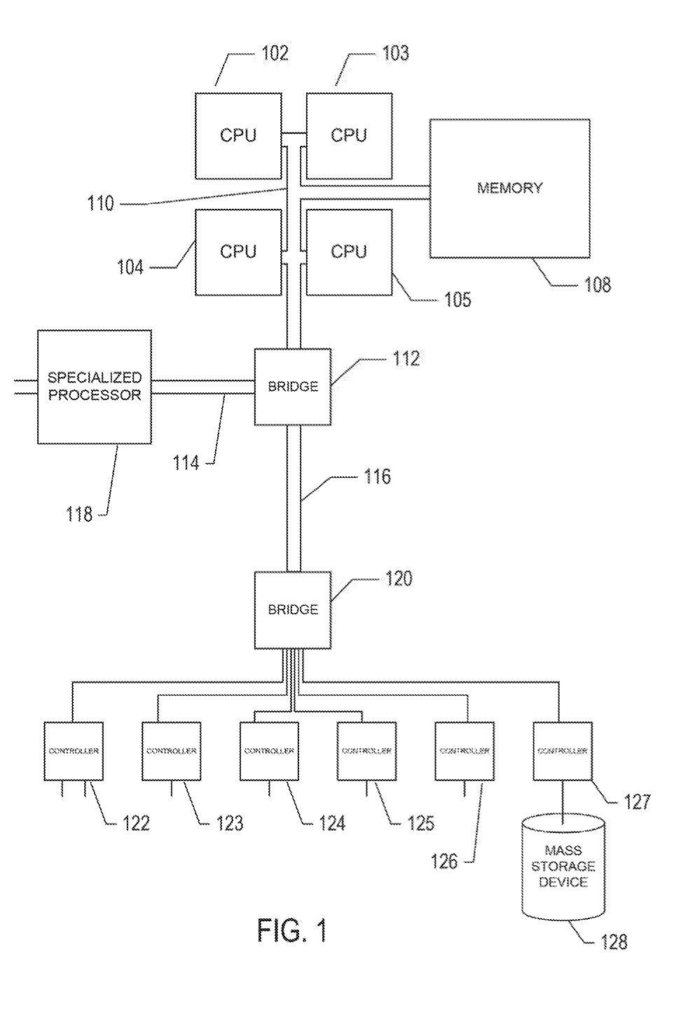

FIG. 1 shows a general architectural diagram for various types of computers. Computers that receive, process, and store event messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational devices. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

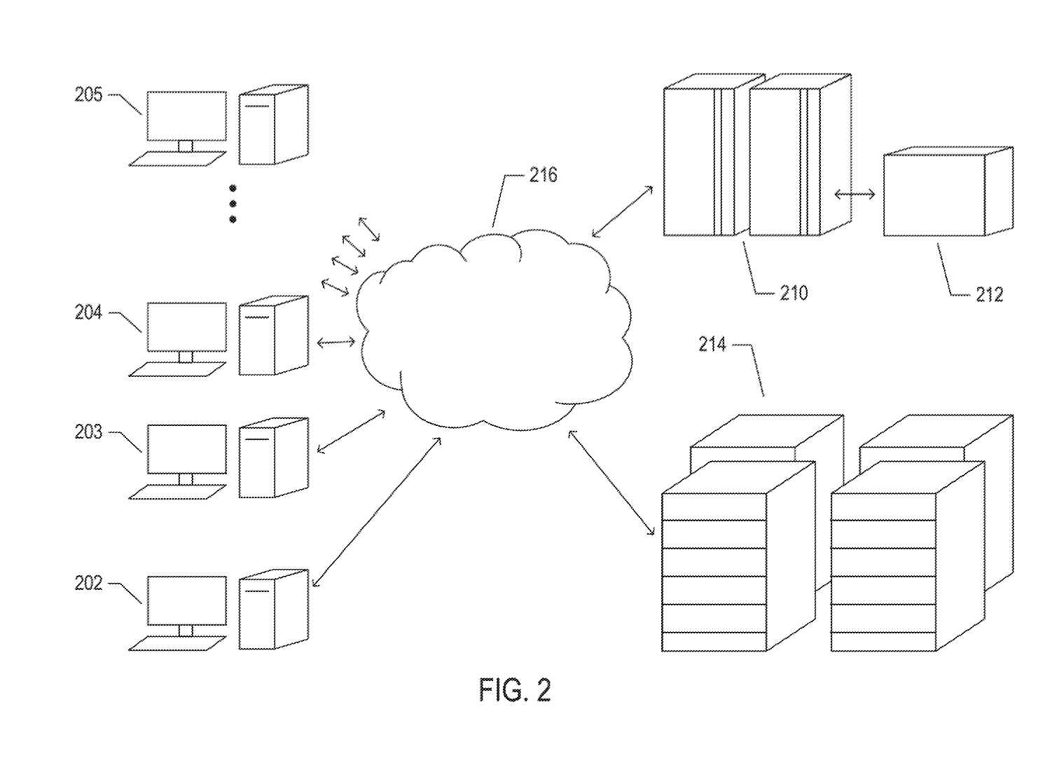

FIG. 2 shows an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user may access hundreds of millions of different web sites provided by hundreds of thousands of different web servers throughout the world and may access high-computational-bandwidth computing services from remote computer facilities for running complex computational tasks.

Until recently, computational services were generally provided by computer systems and datacenters purchased, configured, managed, and maintained by service-provider organizations. For example, an e-commerce retailer generally purchased, configured, managed, and maintained a datacenter including numerous web servers, back-end computer systems, and data-storage systems for serving web pages to remote customers, receiving orders through the web-page interface, processing the orders, tracking completed orders, and other myriad different tasks associated with an e-commerce enterprise.

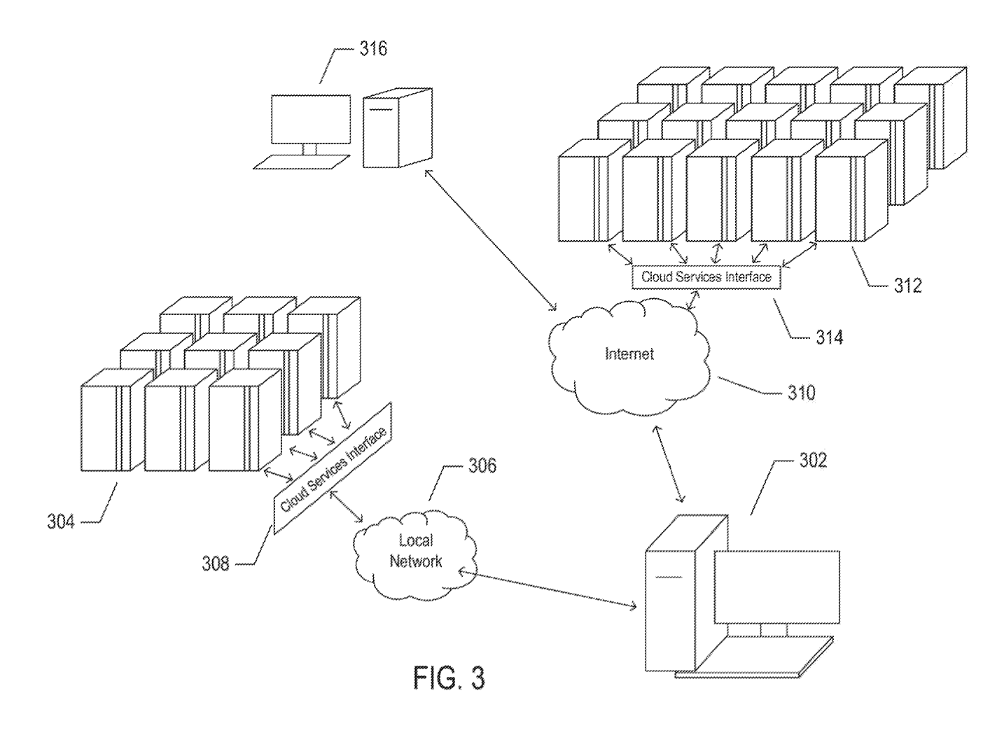

FIG. 3 shows cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual datacenters and launch execution of application programs on the virtual computer systems and virtual datacenters in order to carry out any of many different types of computational tasks. As one example, a small organization may configure and run a virtual datacenter within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the devices to purchase, manage, and maintain in-house datacenters. Such organizations can dynamically add and delete virtual computer systems from their virtual datacenters within public clouds in order to track computational-bandwidth and data-storage needs, rather than purchasing sufficient computer systems within a physical datacenter to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

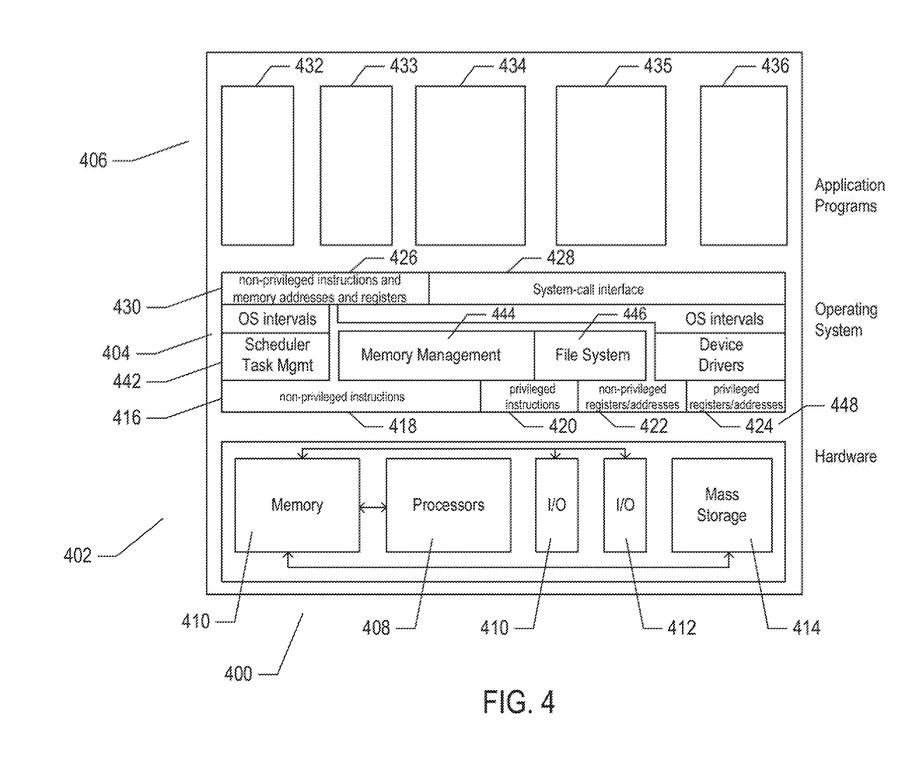

FIG. 4 shows generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor devices and other system devices with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 446 facilitates abstraction of mass-storage-device and memory devices as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

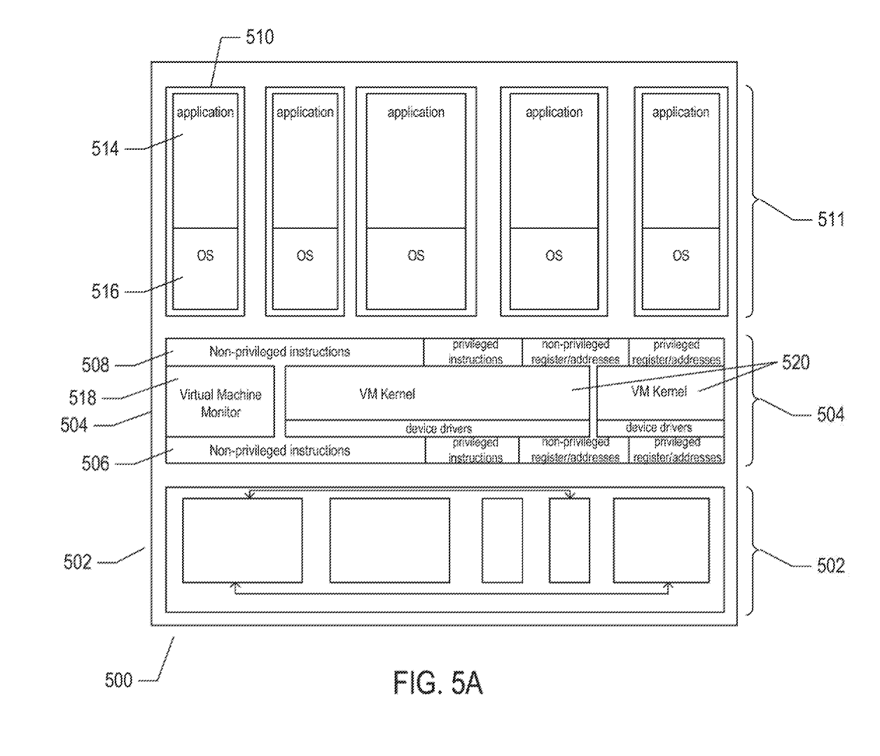

For all of these reasons, a higher level of abstraction, referred to as the “virtual machine,” (“VM”) has been developed and evolved to further abstract computer hardware in order to address many difficulties and challenges associated with traditional computing systems, including the compatibility issues discussed above. FIGS. 5A-B show two types of VM and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment shown in FIG. 5A features a virtualization layer 504 that interfaces through a virtualization-layer/hardware-layer interface 506, equivalent to interface 416 in FIG. 4, to the hardware. The virtualization layer 504 provides a hardware-like interface to a number of VMs, such as VM 510, in a virtual-machine layer 511 executing above the virtualization layer 504. Each VM includes one or more application programs or other higher-level computational entities packaged together with an operating system, referred to as a “guest operating system,” such as application 514 and guest operating system 516 packaged together within VM 510. Each VM is thus equivalent to the operating-system layer 404 and application-program layer 406 in the general-purpose computer system shown in FIG. 4. Each guest operating system within a VM interfaces to the virtualization layer interface 504 rather than to the actual hardware interface 506. The virtualization layer 504 partitions hardware devices into abstract virtual-hardware layers to which each guest operating system within a VM interfaces. The guest operating systems within the VMs, in general, are unaware of the virtualization layer and operate as if they were directly accessing a true hardware interface. The virtualization layer 504 ensures that each of the VMs currently executing within the virtual environment receive a fair allocation of underlying hardware devices and that all VMs receive sufficient devices to progress in execution. The virtualization layer 504 may differ for different guest operating systems. For example, the virtualization layer is generally able to provide virtual hardware interfaces for a variety of different types of computer hardware. This allows, as one example, a VM that includes a guest operating system designed for a particular computer architecture to run on hardware of a different architecture. The number of VMs need not be equal to the number of physical processors or even a multiple of the number of processors.

The virtualization layer 504 includes a virtual-machine-monitor module 518 (“VMM”) that virtualizes physical processors in the hardware layer to create virtual processors on which each of the VMs executes. For execution efficiency, the virtualization layer attempts to allow VMs to directly execute non-privileged instructions and to directly access non-privileged registers and memory. However, when the guest operating system within a VM accesses virtual privileged instructions, virtual privileged registers, and virtual privileged memory through the virtualization layer 504, the accesses result in execution of virtualization-layer code to simulate or emulate the privileged devices. The virtualization layer additionally includes a kernel module 520 that manages memory, communications, and data-storage machine devices on behalf of executing VMs (“VM kernel”). The VM kernel, for example, maintains shadow page tables on each VM so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer 504 essentially schedules execution of VMs much like an operating system schedules execution of application programs, so that the VMs each execute within a complete and fully functional virtual hardware layer.

FIG. 5B shows a second type of virtualization. In FIG. 5B, the computer system 540 includes the same hardware layer 542 and operating system layer 544 as the hardware layer 402 and the operating system layer 404 shown in FIG. 4. Several application programs 546 and 548 are shown running in the execution environment provided by the operating system 544. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The hardware-layer interface 552, equivalent to interface 416 in FIG. 4, provides an execution environment for a number of VMs 556-558, each including one or more application programs or other higher-level computational entities packaged together with a guest operating system.

In FIGS. 5A-5B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

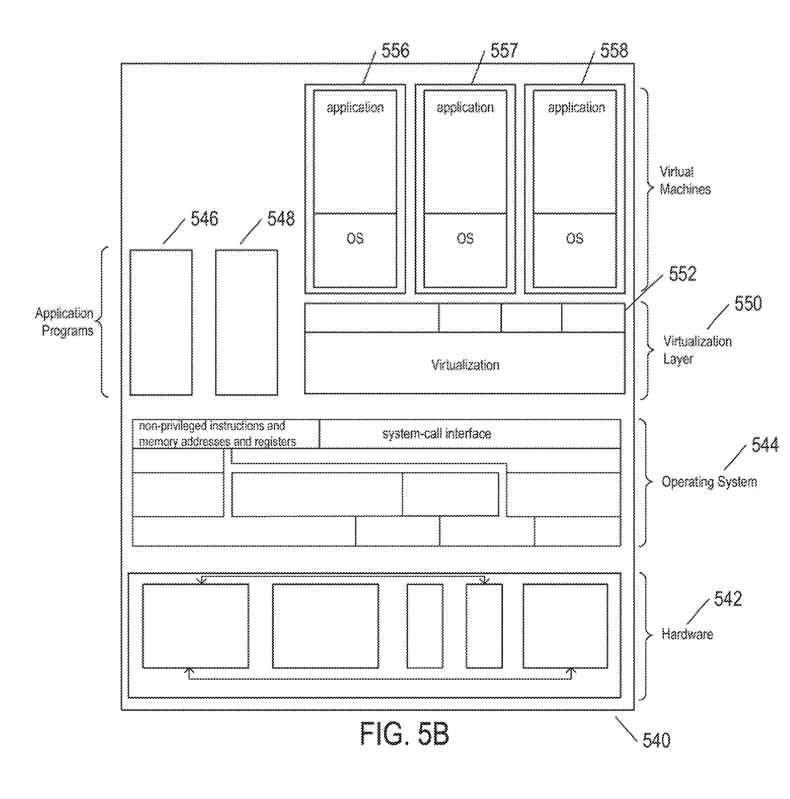

A VM or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a VM within one or more data files. FIG. 6 shows an OVF package. An OVF package 602 includes an OVF descriptor 604, an OVF manifest 606, an OVF certificate 608, one or more disk-image files 610-611, and one or more device files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each VM 634. There are many additional hierarchical levels and elements within a typical OVF descriptor. The OVF descriptor is thus a self-describing, XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and device files 612 are digitally encoded content, such as operating-system images. A VM or a collection of VMs encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more VMs that is encoded within an OVF package.

The advent of VMs and virtual environments has alleviated many of the difficulties and challenges associated with traditional general-purpose computing. Machine and operating-system dependencies can be significantly reduced or entirely eliminated by packaging applications and operating systems together as VMs and virtual appliances that execute within virtual environments provided by virtualization layers running on many different types of computer hardware. A next level of abstraction, referred to as virtual datacenters or virtual infrastructure, provide a data-center interface to virtual datacenters computationally constructed within physical datacenters.

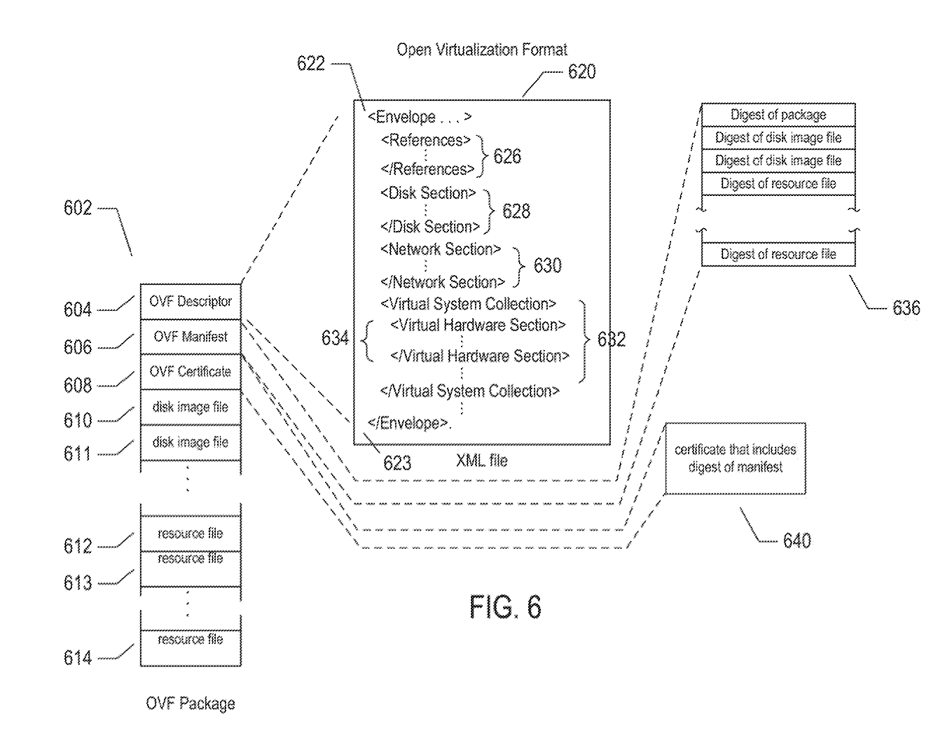

FIG. 7 shows virtual datacenters provided as an abstraction of underlying physical-data-center hardware components. In FIG. 7, a physical datacenter 702 is shown below a virtual-interface plane 704. The physical datacenter comprises a virtual-data-center management server 706 and any of various different computers, such as PCs 708, on which a virtual-data-center management interface may be displayed to system administrators and other users. The physical datacenter additionally includes generally large numbers of server computers, such as server computer 710, that are coupled together by local area networks, such as local area network 712 that directly interconnects server computer 710 and 714-720 and a mass-storage array 722. The physical datacenter shown in FIG. 7 includes three local area networks 712, 724, and 726 that each directly interconnects a bank of eight servers and a mass-storage array. The individual server computers, such as server computer 710, each includes a virtualization layer and runs multiple VMs. Different physical datacenters may include many different types of computers, networks, data-storage systems and devices connected according to many different types of connection topologies. The virtual-interface plane 704, a logical abstraction layer shown by a plane in FIG. 7, abstracts the physical datacenter to a virtual datacenter comprising one or more device pools, such as device pools 730-732, one or more virtual data stores, such as virtual data stores 734-736, and one or more virtual networks. In certain implementations, the device pools abstract banks of physical servers directly interconnected by a local area network.

The virtual-data-center management interface allows provisioning and launching of VMs with respect to device pools, virtual data stores, and virtual networks, so that virtual-data-center administrators need not be concerned with the identities of physical-data-center components used to execute particular VMs. Furthermore, the virtual-data-center management server 706 includes functionality to migrate running VMs from one physical server to another in order to optimally or near optimally manage device allocation, provides fault tolerance, and high availability by migrating VMs to most effectively utilize underlying physical hardware devices, to replace VMs disabled by physical hardware problems and failures, and to ensure that multiple VMs supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual datacenter layer of abstraction provides a virtual-data-center abstraction of physical datacenters to simplify provisioning, launching, and maintenance of VMs and virtual appliances as well as to provide high-level, distributed functionalities that involve pooling the devices of individual physical servers and migrating VMs among physical servers to achieve load balancing, fault tolerance, and high availability.

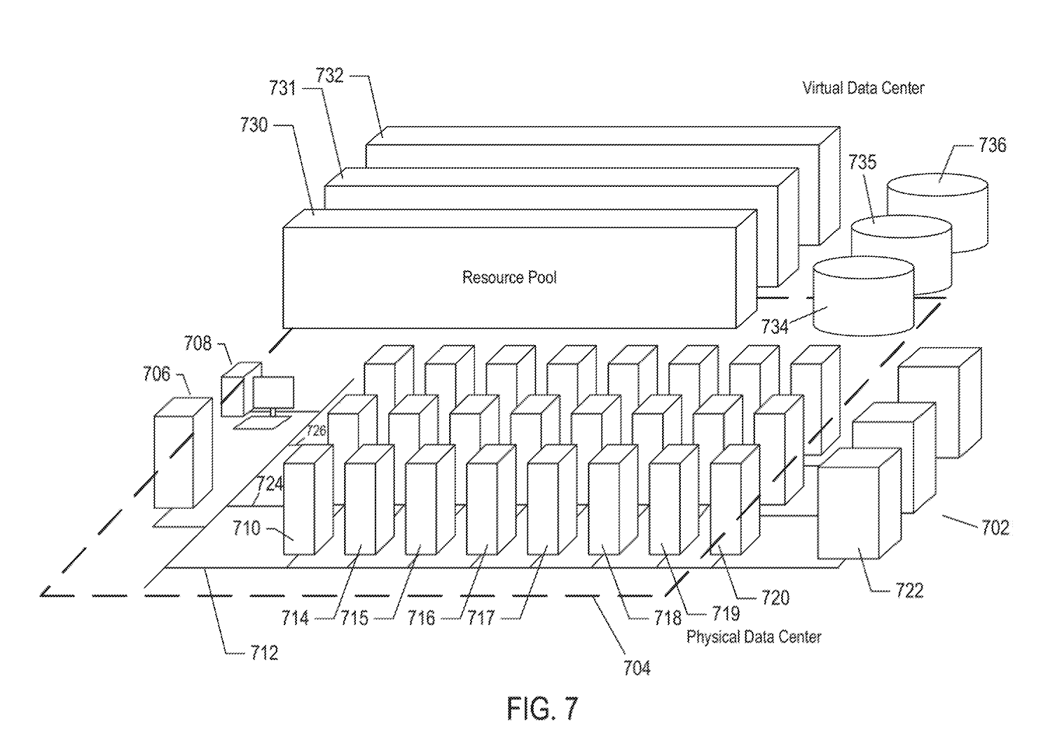

FIG. 8 shows virtual-machine components of a virtual-data-center management server and physical servers of a physical datacenter above which a virtual-data-center interface is provided by the virtual-data-center management server. The virtual-data-center management server 802 and a virtual-data-center database 804 comprise the physical components of the management component of the virtual datacenter. The virtual-data-center management server 802 includes a hardware layer 806 and virtualization layer 808, and runs a virtual-data-center management-server VM 810 above the virtualization layer. Although shown as a single server in FIG. 8, the virtual-data-center management server (“VDC management server”) may include two or more physical server computers that support multiple VDC-management-server virtual appliances. The virtual-data-center management-server VM 810 includes a management-interface component 812, distributed services 814, core services 816, and a host-management interface 818. The host-management interface 818 is accessed from any of various computers, such as the PC 708 shown in FIG. 7. The host-management interface 818 allows the virtual-data-center administrator to configure a virtual datacenter, provision VMs, collect statistics and view log files for the virtual datacenter, and to carry out other, similar management tasks. The host-management interface 818 interfaces to virtual-data-center agents 824, 825, and 826 that execute as VMs within each of the physical servers of the physical datacenter that is abstracted to a virtual datacenter by the VDC management server.

The distributed services 814 include a distributed-device scheduler that assigns VMs to execute within particular physical servers and that migrates VMs in order to most effectively make use of computational bandwidths, data-storage capacities, and network capacities of the physical datacenter. The distributed services 814 further include a high-availability service that replicates and migrates VMs in order to ensure that VMs continue to execute despite problems and failures experienced by physical hardware components. The distributed services 814 also include a live-virtual-machine migration service that temporarily halts execution of a VM, encapsulates the VM in an OVF package, transmits the OVF package to a different physical server, and restarts the VM on the different physical server from a virtual-machine state recorded when execution of the VM was halted. The distributed services 814 also include a distributed backup service that provides centralized virtual-machine backup and restore.

The core services 816 provided by the VDC management server VM 810 include host configuration, virtual-machine configuration, virtual-machine provisioning, generation of virtual-data-center alarms and events, ongoing event logging and statistics collection, a task scheduler, and a device-management module. Each physical server 820-822 also includes a host-agent VM 828-830 through which the virtualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server. The virtual-data-center agents relay and enforce device allocations made by the VDC management server VM 810, relay virtual-machine provisioning and configuration-change commands to host agents, monitor and collect performance statistics, alarms, and events communicated to the virtual-data-center agents by the local host agents through the interface API, and to carry out other, similar virtual-data-management tasks.

The virtual-data-center abstraction provides a convenient and efficient level of abstraction for exposing the computational devices of a cloud-computing facility to cloud-computing-infrastructure users. A cloud-director management server exposes virtual devices of a cloud-computing facility to cloud-computing-infrastructure users. In addition, the cloud director introduces a multi-tenancy layer of abstraction, which partitions VDCs into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical datacenter.

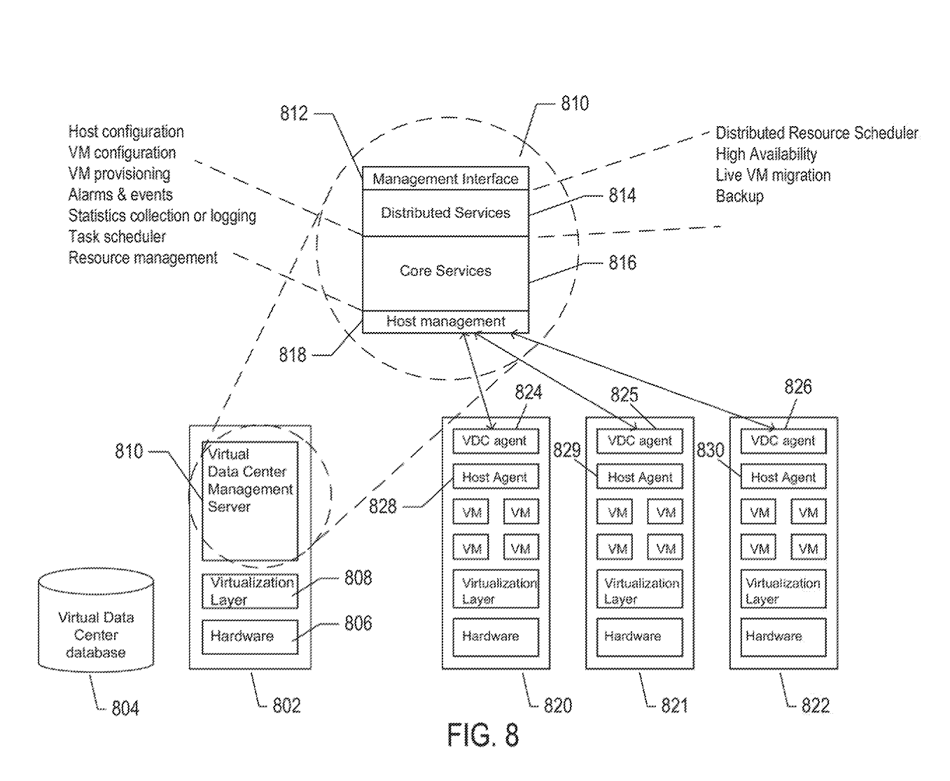

FIG. 9 shows a cloud-director level of abstraction. In FIG. 9, three different physical datacenters 902-904 are shown below planes representing the cloud-director layer of abstraction 906-908. Above the planes representing the cloud-director level of abstraction, multi-tenant virtual datacenters 910-912 are shown. The devices of these multi-tenant virtual datacenters are securely partitioned in order to provide secure virtual datacenters to multiple tenants, or cloud-services-accessing organizations. For example, a cloud-services-provider virtual datacenter 910 is partitioned into four different tenant-associated virtual-datacenters within a multi-tenant virtual datacenter for four different tenants 916-919. Each multi-tenant virtual datacenter is managed by a cloud director comprising one or more cloud-director servers 920-922 and associated cloud-director databases 924-926. Each cloud-director server or servers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual datacenter virtual datacenters on behalf of tenants, tools and interfaces for configuring and managing tenant organizations, tools and services for organization of virtual datacenters and tenant-associated virtual datacenters within the multi-tenant virtual datacenter, services associated with template and media catalogs, and provisioning of virtualization networks from a network pool. Templates are VMs that each contains an OS and/or one or more VMs containing applications. A template may include much of the detailed contents of VMs and virtual appliances that are encoded within OVF packages, so that the task of configuring a VM or virtual appliance is significantly simplified, requiring only deployment of one OVF package. These templates are stored in catalogs within a tenant's virtual-datacenter. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual datacenters into heterogeneous or homogeneous aggregations of cloud-computing facilities.

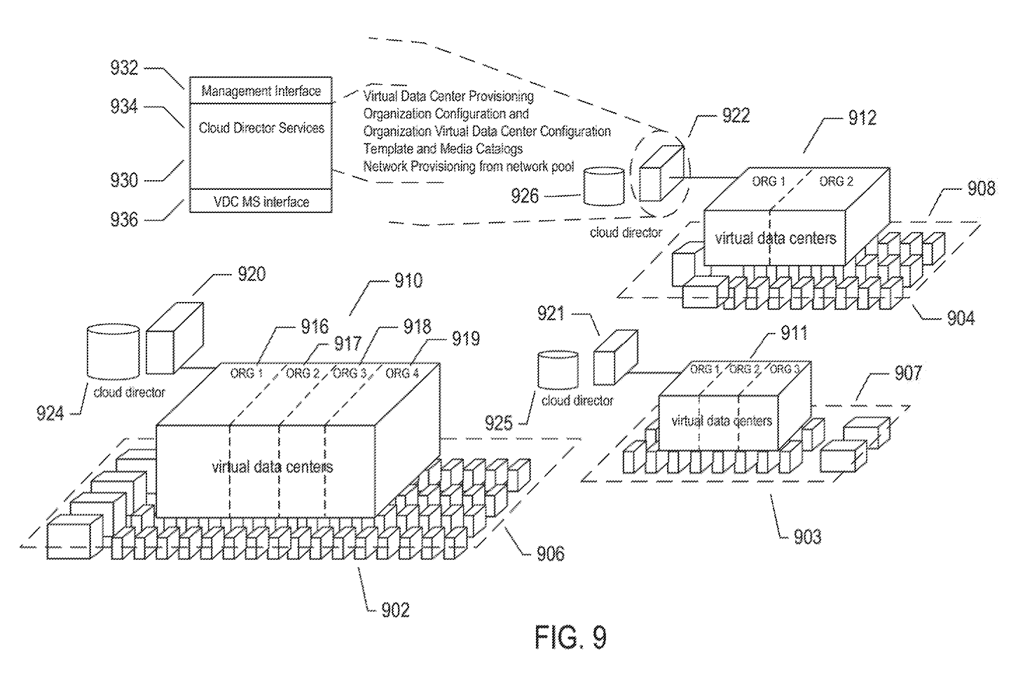

FIG. 10 shows virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are shown 1002-1008. Cloud-computing facility 1002 is a private multi-tenant cloud with a cloud director 1010 that interfaces to a VDC management server 1012 to provide a multi-tenant private cloud comprising multiple tenant-associated virtual datacenters. The remaining cloud-computing facilities 1003-1008 may be either public or private cloud-computing facilities and may be single-tenant virtual datacenters, such as virtual datacenters 1003 and 1006, multi-tenant virtual datacenters, such as multi-tenant virtual datacenters 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

### Containers and Containers Supported by Virtualization Layers

As mentioned above, while the virtual-machine-based virtualization layers, described in the previous subsection, have received widespread adoption and use in a variety of different environments, from personal computers to enormous distributed computing systems, traditional virtualization technologies are associated with computational overheads. While these computational overheads have steadily decreased, over the years, and often represent ten percent or less of the total computational bandwidth consumed by an application running above a guest operating system in a virtualized environment, traditional virtualization technologies nonetheless involve computational costs in return for the power and flexibility that they provide.

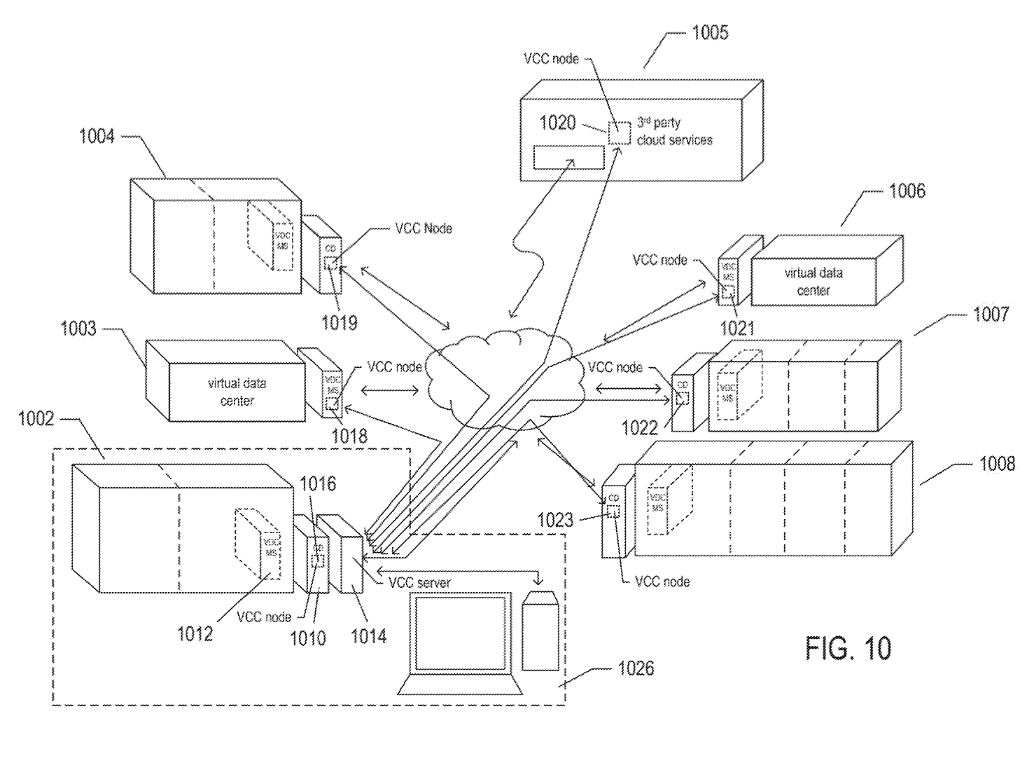

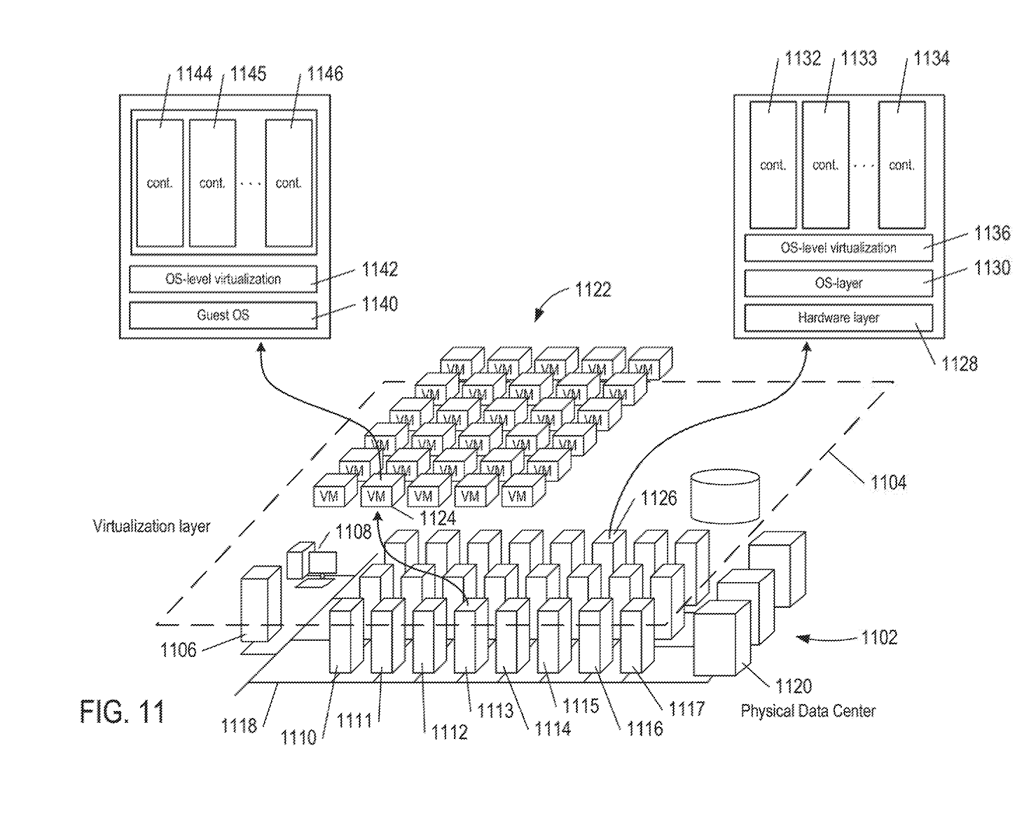

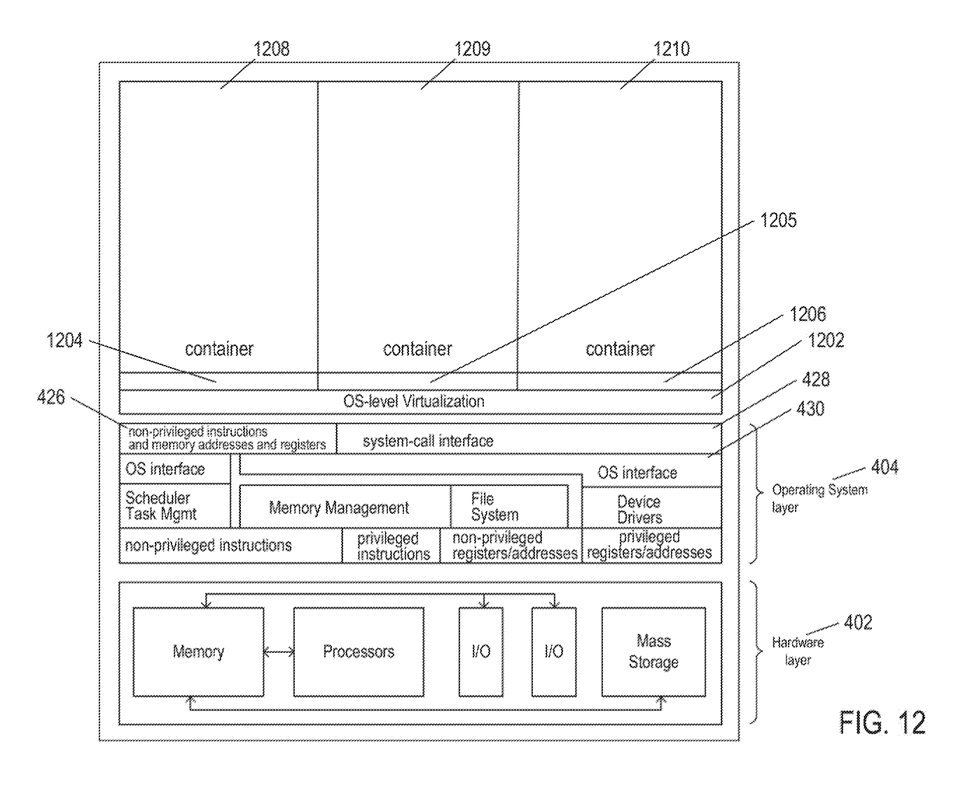

Another approach to virtualization, as also mentioned above, is referred to as operating-system-level virtualization (“OSL virtualization”). FIG. 11 shows two ways in which OSL virtualization may be implemented in a physical datacenter 1102. In FIG. 11, the physical datacenter 1102 is shown below a virtual-interface plane 1104. The physical datacenter 1102 comprises a virtual-data-center management server 1106 and any of various different computers, such as PCs 1108, on which a virtual-data-center management interface may be displayed to system administrators and other users. The physical datacenter 1100 additionally includes a number of server computers, such as server computers 1110-1117, that are coupled together by local area networks, such as local area network 1118, that directly interconnects server computers 1110-1117 and a mass-storage array 1120. The physical datacenter 1102 includes three local area networks that each directly interconnects a bank of eight server computers and a mass-storage array. Certain server computers have a virtualization layer that run multiple VMs 1122. For example, server computer 1113 has a virtualization layer that is used to run VM 1124. Certain VMs and server computers may be used to host a number of containers. A server computer 1126 has a hardware layer 1128 and an operating system layer 1130 that is shared by a number of containers 1132-1134 via an OSL virtualization layer 1136 as described in greater detail below with reference to FIG. 12. Alternatively, the VM 1124 has a guest operating system 1140 and an OSL virtualization layer 1142. The guest operating system 1140 is shared by a number of containers 1144-1146 via the OSL virtualization layer 1142 as described in greater detail below with reference to FIG. 13.

While a traditional virtualization layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system of the host. In essence, OSL virtualization uses operating-system features, such as namespace isolation, to isolate each container from the other containers running on the same host. In other words, namespace isolation ensures that each application is executed within the execution environment provided by a container to be isolated from applications executing within the execution environments provided by the other containers. A container cannot access files not included the container's namespace and cannot interact with applications running in other containers. As a result, a container can be booted up much faster than a VM, because the container uses operating-system-kernel features that are already available and functioning within the host. Furthermore, the containers share computational bandwidth, memory, network bandwidth, and other computational resources provided by the operating system, without the overhead associated with computational resources allocated to VMs and virtualization layers. Again, however, OSL virtualization does not provide many desirable features of traditional virtualization. As mentioned above, OSL virtualization does not provide a way to run different types of operating systems for different groups of containers within the same host and OSL-virtualization does not provide for live migration of containers between hosts, high-availability functionality, distributed resource scheduling, and other computational functionality provided by traditional virtualization technologies.

FIG. 12 shows an example server computer used to host three containers. As discussed above with reference to FIG. 4, an operating system layer 404 runs above the hardware 402 of the host computer. The operating system provides an interface, for higher-level computational entities, that includes a system-call interface 428 and the non-privileged instructions, memory addresses, and registers 426 provided by the hardware layer 402. However, unlike in FIG. 4, in which applications run directly above the operating system layer 404, OSL virtualization involves an OSL virtualization layer 1202 that provides operating-system interfaces 1204-1206 to each of the containers 1208-1210. The containers, in turn, provide an execution environment for an application that runs within the execution environment provided by container 1308. The container can be thought of as a partition of the resources generally available to higher-level computational entities through the operating system interface 430.

FIG. 13 shows an approach to implementing the containers on a VM. FIG. 13 shows a host computer similar to that shown in FIG. 5A, discussed above. The host computer includes a hardware layer 502 and a virtualization layer 504 that provides a virtual hardware interface 508 to a guest operating system 1302. Unlike in FIG. 5A, the guest operating system interfaces to an OSL-virtualization layer 1304 that provides container execution environments 1306-1308 to multiple application programs.

Note that, although only a single guest operating system and OSL virtualization layer are shown in FIG. 13, a single virtualized host system can run multiple different guest operating systems within multiple VMs, each of which supports one or more OSL-virtualization containers. A virtualized, distributed computing system that uses guest operating systems running within VMs to support OSL-virtualization layers to provide containers for running applications is referred to, in the following discussion, as a “hybrid virtualized distributed computing system.”

Running containers above a guest operating system within a VM provides advantages of traditional virtualization in addition to the advantages of OSL virtualization. Containers can be quickly booted in order to provide additional execution environments and associated resources for additional application instances. The resources available to the guest operating system are efficiently partitioned among the containers provided by the OSL-virtualization layer 1304 in FIG. 13, because there is almost no additional computational overhead associated with container-based partitioning of computational resources. However, many of the powerful and flexible features of the traditional virtualization technology can be applied to VMs in which containers run above guest operating systems, including live migration from one host to another, various types of high-availability and distributed resource scheduling, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides for flexible and scaling over large numbers of hosts within large distributed computing systems and a simple approach to operating-system upgrades and patches. Thus, the use of OSL virtualization above traditional virtualization in a hybrid virtualized distributed computing system, as shown in FIG. 13, provides many of the advantages of both a traditional virtualization layer and the advantages of OSL virtualization.

### Methods and Systems to Determine Virtual Storage Costs in a Virtual Datacenter

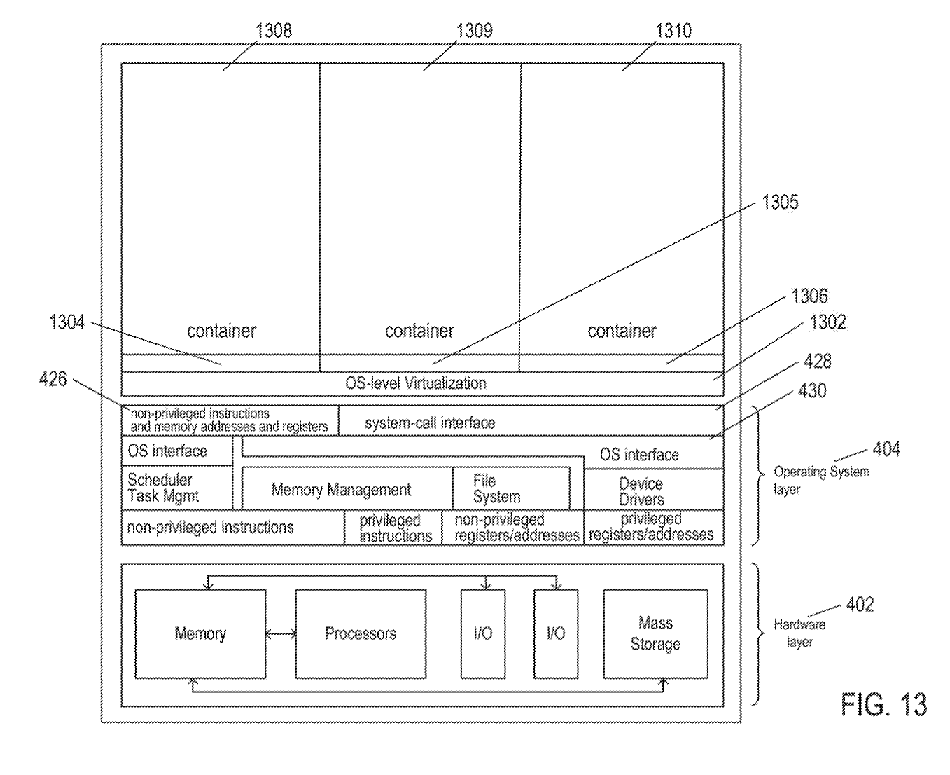

FIG. 14 shows an example of a cloud-computing facility 1400. The cloud-computing facility 1400 includes a virtual-data-center management server 1401 and a PC 1402 on which a virtual-data-center management interface may be displayed to system administrators and other users. The cloud-computing facility 1400 additionally includes a number of hosts or server computers, such as server computers 1404-1407, that are interconnected to form three local area networks 1408-1410. For example, local area network 1408 includes a switch 1412 that interconnects the four servers 1404-1407 and a mass-storage array 1414 via Ethernet or optical cables and local area network 110 includes a switch 1416 that interconnects four servers 1418-1421 and a mass-storage array 1422 via Ethernet or optical cables. In this example, the cloud-computing facility 1400 also includes a router 1424 that interconnects the LANs 1408-1410 and interconnects the LANs to the Internet, the virtual-data-center management server 1401, the PC 1402 and to a router 1426 that, in turn, interconnects other LANs comprised of server computers and mass-storage arrays (not shown). The routers and switches are network devices that are interconnected to form a network of server computers.

The physical storage of the server computers and mass-storage devices of the cloud-computing facility 1400 may be used to create virtual storage for VMs of a VDC. Virtual storage may be created by virtualizing the solid-state drives (“SSDs”) and hard disk drives (“HDDs”) of the server computers and the mass-storage arrays.

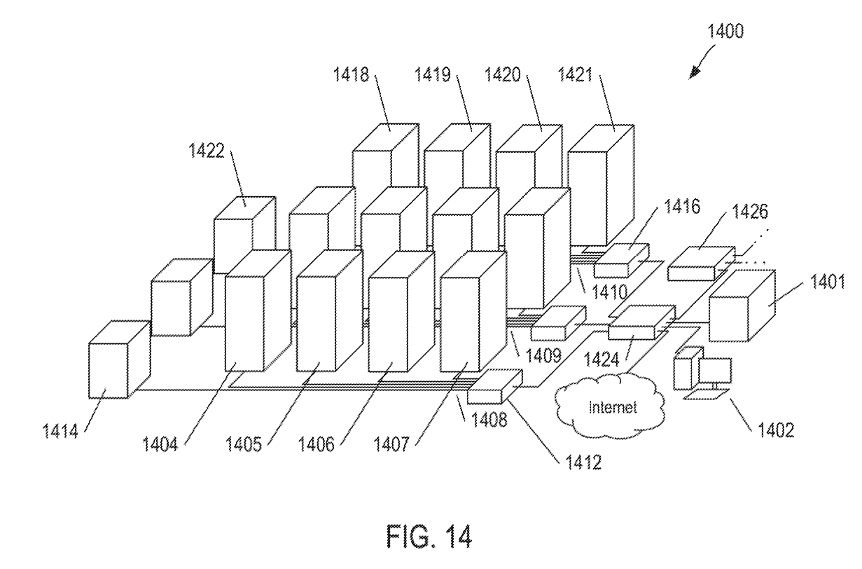

FIG. 15 shows an example of virtual storage 1502 above a virtual interface plane 1504. Each server computer of the cloud-computing facility 1400 includes one or more SSDs and one or more HDDs. For example, server computer 1404 includes SSDs 1506 and HDDs 1508, and server computer 1406 includes SSDs 1510 and HDDs 1512. Mass-storage array 1414 includes SSDs 1514 and HDDs 1516. As shown in FIG. 15, the virtual storage 1502 is separated into virtual disk storage 1518 and virtual cache storage 1520. The virtual disk storage 1518 is formed by pooling or aggregating the HDDs of the server computers and mass-storage arrays. The virtual cache storage 1520 is formed by pooling or aggregating the SSDs of the server computers and mass-storage arrays.

The virtual disk storage may be partitioned into virtual disks (“VDs”) that serve as virtual disk drives of the VMs. Each VM may have one or more associated VDs. The virtual cache storage 1520 is used for read caching and write buffering of data sent between a VM and the one or more associated VDs.

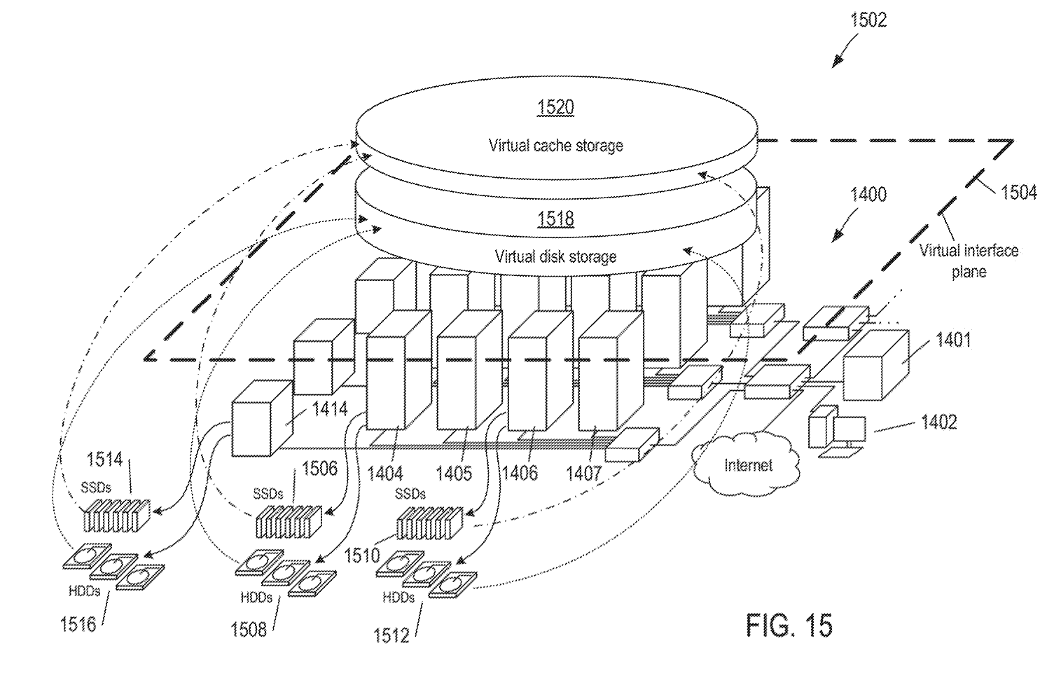

FIG. 16 shows an array of VMs 1602 above the virtual storage 1502 and virtual interface plane 1504. The VMs are represented by boxes, such as box 1604. The VMs 1602 may form VDC. The virtual disk storage 1518 is partitioned into VDs. Each VD of the virtual disk storage 1518 serves as a virtual disk drive of a VM. Each of the VMs may have one or more associated VDs. Dashed line cylinders, such as dashed line cylinder 1606, represent VDs created within the virtual disk storage 1518. Because the HDDs are slower at reading and writing data than the SSDs, each VD created in the virtual disk storage 1518 is allocated space in the virtual cache storage 1520, which is used for read caching and write buffering. Read caching and write buffering increase the read and write performance of the VMs. Read caching means data once read from the VDs is held in a read cache of the virtual cache storage 1520 and if required again the data is read from the read cache. If any data is not found in a read cache, the VM fetches the data from the associated VDs in the virtual disk storage 1518. Similarly, in order to optimize the time used to write data, data is first written to a write buffer in the virtual cache storage 1520, and at a later point in time the data is written to the virtual cache storage 1520. The read caches and write buffers are SSDs or portions of SDDs in one or more of the server computers or mass-storage devices. Each read cache temporally stores a copy of data retrieved from a VD. Each write buffer temporally stores data generated by a VM before writing the data to a VD. For example, VM 1604 stores data at a corresponding VD 1606. The VD may be an HDD or stripes of one or more HDDs. Data read from the VD 1606 is temporally copied to a read cache represented by a cylinder 1608 before the data is fetched and processed at the VM 1604. Data generated by VM 1604 is written to a write buffer represented by a cylinder 1610. The write buffer 1610 may serve as main memory for the VM 1604, hold the data for a next cache in a memory hierarchy of the VM 1604, or hold the data before the data is written to the VD 1606.

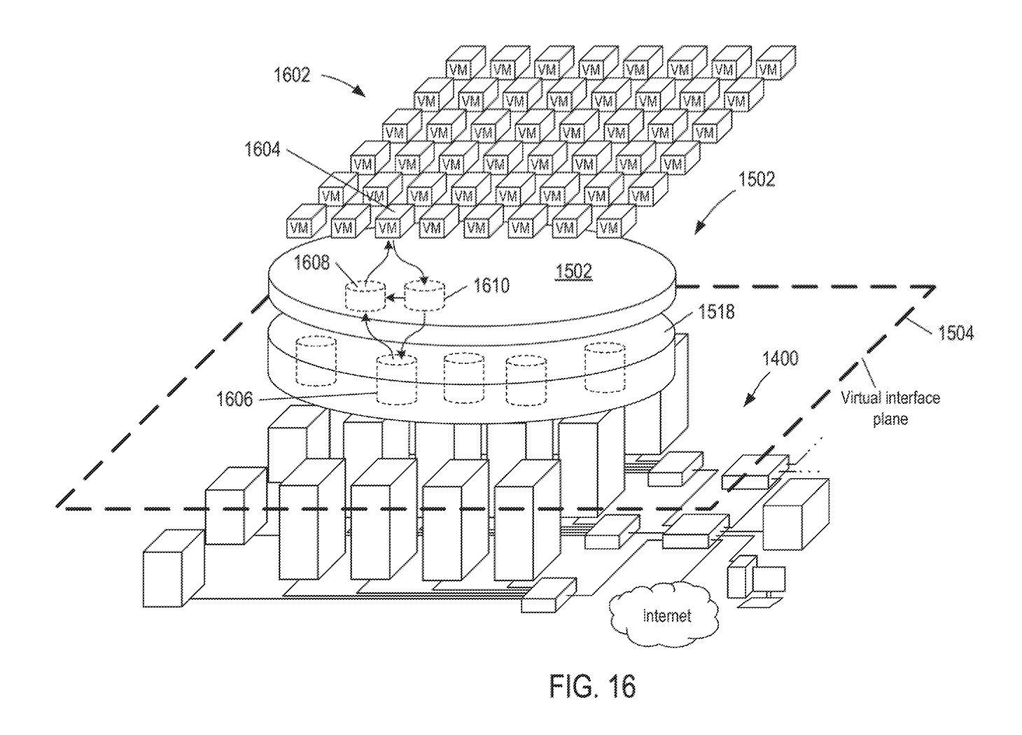

Policies govern the number of copies of data created, where the copies are stored, and reservations in the virtual cache storage may be recorded in a service level agreement between the IT service provider that manages the cloud-computing facility and the customers running their applications in the cloud-computing facility. FIG. 17 shows an example of a virtual storage management policy with details presented in the form of a table. The virtual storage policy comprises five rules as part of a rule set for managing virtual storage of VMs. The policy requirements are used to govern how VMs of a VDC use the virtual storage when VMs are created. VDs of the VMs are distributed across the virtual disk storage according to the policy requirements. Note that when a storage policy is not applied to a VM, a default virtual storage policy is used with a default number of failures to tolerate and a single disk stripe per HDD.

Methods compute a total cost of virtual storage in periods of time based on cost factors, that include, but are not limited to, hardware, network, labor, licensing, maintenance and others devices associated with the set up and maintenance of the virtual storage created in a cloud-computing facility. A ‘period’ may be a billing period, a billing cycle, or any recurring duration of time for which IT services are provided and charged to an IT customer. For example, a period may be a week, two weeks, 20 days, 30 days, 45 days, a month, three months, or four months.

The cost of each SSD, HDD, Ethernet card, router, and switch purchased to form the portion of the cloud-computing facility used to provide virtual storage to VMs of VDC are recorded in one or more ledgers. Methods read the ledgers to obtain the cost of each HDD, SSD, Ethernet card, router, and switch of the cloud-computing facility. Consider a cloud-computing facility having N server computers and mass-storage devices dedicated to creating virtual storage for a VDC comprised of N_{VM} VMs. The total cost of the HDDs of the cloud-computing facility is

$${TC}_{HDD} = {\sum }_{i = 1}^{N} {DiskCost}_{HDD}^{i} \qquad ( 1 )$$

where DiskCost_{HDD}ⁱ is the cost of the HDDs in the ith server computer or mass-storage device of the cloud-computing facility.

The total cost of the SSDs of the cloud-computing facility is

$${TC}_{SSD} = {\sum }_{i = 1}^{N} {DiskCost}_{SSD}^{i} \qquad ( 2 )$$

where DiskCost_{SSD}ⁱ is the cost of the SSDs in the ith server computer or mass-storage device of the cloud-computing facility.

The total network cost for the cloud-computing facility is

$${TC}_{Network} = {TC}_{NIC} + {\sum }_{i = 1}^{ND} {NetworkDeviceCost}^{i} \qquad ( 3 )$$

where
ND is the number of network devices in the cloud-computing facility used to form the virtual storage;
NetworkDeviceCostⁱ is the cost of the ith network device in the cloud-computing facility; and
TC_{NIC} is the total cost of dedicated Ethernet cards for data transfer in the virtual storage.
   The network devices may be routers and switches of the cloud-computing facility. For example, in FIG. 14, the network devices used to form the cloud-computing facility are the switches and the routers. The total cost of dedicated Ethernet cards used for data transfer in the cloud-computing facility is

$${TC}_{NIC} = {\sum }_{i = 1}^{N} {NicCost}^{i} \qquad ( 4 )$$

where NicCostⁱ is the cost of the Ethernet card in the ith server computer or mass-storage device of the cloud-computing facility.

The total licensing cost depends on the number of CPUs in each server computers of the cloud-computing facility. The yearly virtual storage cost per CPU, denoted by YC_{License} per CPU, may be read from a license reference cost database. The total number of CPUs in the server computers used to form the virtual storage is

$${Count}_{CPU} = {\sum }_{i = 1}^{NH} {HostCPUCount}^{i} \qquad ( 5 )$$

where
NH is the number of server computers or hosts in the cloud-computing facility used to form the virtual storage; and
HostCPUCountⁱ is the number of CPUs in the ith server computer.
   The total licensing cost of using the CPUs is given by

TC_{License}=YC_{License} per CPU*Count_{CPU} (6)

where ‘*’ represents multiplication.

The total costs of HDDs, SSDs, network and licensing described above in Equations (1)-(6) are adjusted for depreciation. A depreciable value of an asset, denoted by DF(Cost, PurchaseDate), gives the yearly value of the asset in a given year based on the cost at the purchase date and useful life of the asset. The asset is an HDD, SSD, and network. For example, ‘Cost’ denotes the cost of an HDD, SSD, or a network device at the purchase data, denoted ‘PurchaseDate.’ The depreciation value may be calculated using straight-line depreciation, double declining balance depreciation, or another method of determining depreciation of an asset over the useful life of the assert.

Let N_{P} denote the number of periods considered in calculated the cost. For example, if the period is a month, then N_{P} equals 12. The depreciation cost of the HDDs over the period is

$${C}_{HDD} = {\sum }_{i = 1}^{N} \frac{DF ( {DiskCost}_{HDD}^{i} , {PurchaseDate}_{HDD}^{i} )}{{N}_{P}} \qquad ( 7 )$$

where DF(DiskCost_{HDD}ⁱ, PurchaseDate_{HDD}ⁱ) is the depreciation value of the HDDs of the ith server computer or mass-storage device with cost DiskCost_{HDD}ⁱ purchased on PurchaseDate_{HDD}ⁱ.

The depreciation cost of the SSDs over the period is

$${C}_{SSD} = {\sum }_{i = 1}^{N} \frac{DF ( {DiskCost}_{SSD}^{i} , {PurchaseDate}_{SSD}^{i} )}{{N}_{P}} \qquad ( 8 )$$

where DF(DiskCost_{SDD}ⁱ, PurchaseDate_{SDD}ⁱ) is the depreciation value of the SSDs of the ith server computer or mass-storage device with cost DiskCost_{SDD}ⁱ purchased on PurchaseDate_{SDD}ⁱ.

The depreciation cost of the network of the cloud-computing facility over the period is

$${C}_{Network} = {\sum }_{i = 1}^{N} \frac{DF ( {NicCost}^{i} , {PurchaseDate}_{Nic}^{i} )}{{N}_{P}} + {\sum }_{i = 1}^{ND} \frac{DF ( {NDCost}^{i} , {PurchaseDate}_{ND}^{i} )}{{N}_{P}} \qquad ( 9 )$$

where
DF(NicCostⁱ, PurchaseDate_{SDD}ⁱ) is the depreciation value of the Ethernet card of the ith server computer or mass-storage device with cost NicCostⁱ purchased on the date of purchase PurchaseDate_{SDD}ⁱ; and
DF(NDCostⁱ, PurchaseDate_{ND}ⁱ) is the depreciation value of the ith network device with cost NDCostⁱ purchased on the date of purchase PurchaseDate_{ND}ⁱ.
   The license cost is calculated over the period as follows:

$${C}_{License} = \frac{{TC}_{License}}{{N}_{P}} \qquad ( 10 )$$

The labor cost, C_{Labor}, maintenance cost, C_{Maintenance}, and cost of cloud-computing facility, C_{Facilities}, over the period may be obtained from the IT customer's expense reports that are maintained by IT service provider and may be obtained from ledgers. The labor cost may be calculated as a product of cost per hour, hourly wage, and total number of labor hours in the period. The maintenance cost may be calculated as a sum of expenditures in maintaining the hardware and software upgrades and new software in the period. The facilities cost may be calculated as a sum cost of real estate of the cloud-computing facility, power, and cooling over the period.

The total virtual storage cost is given by

$${C}_{VirtualStorage} = {C}_{HDD} + {C}_{SSD} + {C}_{License} + {C}_{Labor} + {C}_{Maintenance} + {C}_{Facilities} \qquad ( 11 )$$

Note that the virtual storage cost C_{VirtualStorage} does not include the network cost C_{Network}. Network cost is not recovered through the storage capacity of VMs but is instead recovered based on disk striping parameter values of set in the policy governing the VDs of VMs:

C_{Striping}=C_{Network} (12)

The total HDD cost TC_{HDD} and the total SSD cost TC_{SSD} may be used to calculate separate base rates for the HDDs and the SSDs, which are used to allocate the virtual storage cost to each of the VMs in the VDC. The fully loaded HDD cost of the HDDs in the cloud-computing facility used to form the virtual disk storage is

$${FLC}_{HDD} = {C}_{VirtualStorage} * \frac{{TC}_{HDD}}{{TC}_{HDD} + {TC}_{SSD}} \qquad ( 13 )$$

The fully loaded SSD cost of the SSDs in the cloud-computing facility used to form the virtual cache storage is

$${FLC}_{SSD} = {C}_{VirtualStorage} * \frac{{TC}_{SSD}}{{TC}_{HDD} + {TC}_{SSD}} \qquad ( 14 )$$

The total storage capacity of the HDDs is

$${Capacity}_{HDD} = {\sum }_{i = 1}^{N} {DiskCapacity}_{HDD}^{i} \qquad ( 15 )$$

where DiskCapacity_{HDD}ⁱ is the storage capacity of the HDDs of the ith server computer or mass-storage device.

The total storage capacity of the SSDs is

$${Capacity}_{SSD} = {\sum }_{i = 1}^{N} {DiskCapacity}_{SSD}^{i} \qquad ( 16 )$$

where DiskCapacity_{SDD}ⁱ so is the storage capacity of the SSDs of the ith server computer or mass-storage device.

The HDD cost rate (e.g., S/GB) for the HDD storage space of the cloud-computing facility is

$${U}_{HDD} = \frac{{FLC}_{HDD}}{{Capacity}_{HDD}} \qquad ( 17 )$$

The SSD cost rate (e.g., S/GB) for the SSD storage space of the cloud-computing facility is

$${U}_{SSD} = \frac{{FLC}_{SSD}}{{Capacity}_{SSD}} \qquad ( 18 )$$

The virtual storage cost of a VM in the VDC depends on the storage policy assigned to the VM. Each VD of a VM may have a different storage policy, such as the policies described above with reference to FIG. 17. Each VD is created and operated according to the parameters of the virtual management storage policy. The parameters are used to calculate the storage cost of the VD. The information about the VMs, VDs and the storage policy parameters may be determined from APIs and storage policy based management APIs. Each of the virtual storage policy parameters of the virtual storage management policy shown in FIG. 17 is considered below.

Failure to Tolerate: The ‘failure to tolerate’ policy governs the number of copies of data that can be stored in a VD. The number of copies of data that can be stored in the VD is denoted by P_{FTT} and represents the failure to tolerate value. The storage cost of a VD over the period governed by a failure to tolerate policy is given by

StorageC_{VD}=(P_{FTT}+1)*UC_{VD}*U_{HDD} (19)

where UC_{VD} is the used capacity of the VD.

Consider a VM having a VD with a storage capacity of 20 GB that is managed according to a ‘Failure to tolerate’ policy with a failure to tolerate value P_{FTT}=2. The actual size occupied by the VD in the virtual disk storage is (2+1)*20=60 GB. The storage cost of the VD is StorageC_{VD}=(2+1)*20*U_{HHD}.

Disk Striping: The ‘disk striping’ policy governs the number of HDDs used to distribute and store data of a VD across multiple HDDs. Disk striping is the process of dividing data into blocks and storing the blocks of data across in multiple HDDs. Data distributed across multiple HDDs may be stored as stripes of data across multiple HDDs belonging to different server computers. A stripe comprises data divided across the HDDs and a striped unit, or strip, is the data slice on an individual HDD. A large data set stored in a VD that in turn is comprised of stripes stored across multiple I-HDDs results in better read and write performance, because the large data set may be read simultaneously from the multiple HDDs. Reading data across different server computers often results in larger network usage among the server computers. The striping cost, StripingC_{VD}, of a VD is calculated as follows. The total number of stripes of a VD is given by:

StripesCount_{VD}=P_{DS}*(P_{FTT}+1) (20)

where P_{DS} is the number of HDDs used to store stripes of data for the VD.

The total number of stripes across the VDs of the virtual disk storage is given by

$${Count}_{Stripe} = {\sum }_{i = 1}^{{N}_{VD}} {StripesCount}_{VD}^{i} \qquad ( 21 )$$

where
N_{VD} is the number of VDs in the virtual disk storage; and
StripesCount_{VD}ⁱ is the stripe count of the ith VD.
   The unit cost rate per stripe is given by

$${U}_{Stripe} = \frac{{C}_{Striping}}{{Count}_{Stripe}} \qquad ( 22 )$$

where C_{Striping}=C_{Network}.

The disk striping cost of a VD over the period is given by:

StripingC_{VD}=StripesCount_{VD}*U_{Stripe} (23)

Force Provisioning: The ‘force provisioning’ policy is set to NO in production. In other words, the virtual disk storage may be provisioned to the VDs based on the policy the VDs belong to. The force provisioning does not affect the cost.

Object Space Reservation: The ‘object space reservation’ policy governs the percentage of virtual disk storage to be reserved while creating a VD. The policy governs internal reservation to prevent over committing of virtual disk storage space to VMs. The object space reservation policy does not affect the cost.

Read Cache Reservation: The ‘read cache reservation’ policy governs the fraction or percentage of the SSDs set aside for read caching and write buffering. As described above with reference to FIG. 16, the SSDs of the virtual cache storage are not used for data storage, but are instead used for read caching and write buffering. The read cache reservation sets aside a fraction of SSD capacity denoted by F_{RC}, where 0<F_{RC}<1. The fraction of SSD capacity set aside for write buffering is F_{WB}=(1−F_{RC}). A larger read cache reservation results in a faster read rate. A read cache capacity of the virtual cache storage reserved for read caching is

RCCapacity_{SSD}=F_{RC}*Capacity_{SSD} (24)

A write buffer capacity the virtual cache storage reserved for write buffering is

WBCapacity_{SSD}=F_{WB}*Capacity_{SSD} (25)

A read cache reservation value, P_{RCR}, of the read cache reservation policy of the read cache capacity of the SSD space reserved for each VD is calculated as follows:

RCCapacity_{VD}=P_{RCR}*0.01*Capacity_{VD} (26)

The read cache cost of each VD is calculated as follows:

$${RCCcost}_{VD} = {RCCapacity}_{VD} * {U}_{SSD} + \frac{{RR}_{VD}}{{\sum }_{i = 1}^{{N}_{VD}} {RR}_{VD}^{i}} * ( {RCCapacity}_{SSD} - {\sum }_{i = 1}^{{N}_{VD}} {RRCapacity}_{VD}^{i} ) * {U}_{SSD} \qquad ( 27 )$$

where RR_{VD} is the read rate of the VD (e.g., Kb/second).

The remaining read cache space may be equally divided for the VDs based on each VD's read rate ratio. The write buffer cost of a VD is calculated based on the ratio of the VDs write rate ratio to total write buffer of the VDs as follows:

$${WBCcost}_{VD} = \frac{{WR}_{VD}}{{\sum }_{i = 1}^{{N}_{VD}} {WR}_{VD}^{i}} * {WBCapacity}_{SSD} * {U}_{SSD} \qquad ( 28 )$$

where WR_{VD} is the write rate of the VD (e.g., Kb/second).

The cost of a VD over the period is given by

C_{VD}=StorageC_{VD}+StripingC_{VD}+RCCost_{VD}+WBCost_{VD} (29)

The VM storage cost of a VM having M VDs is given by

$${C}_{VMStorage} = {\sum }_{i = 1}^{M} {C}_{VD}^{i} \qquad ( 30 )$$

The VM storage cost may be calculate for each VM of the VDC according to Equation (18) and summed to obtain the virtual storage cost of the VDC. The VM storage cost or the virtual storage cost of the VDC may be used to calculate a price for IT services. For example, the price of a virtual machine may be calculated as Price_{VM}=Margin_{VM}+C_{VMStorage}, where Margin_{VM} is the profit margin and Price_{VM} is the price charged to the IT customer.

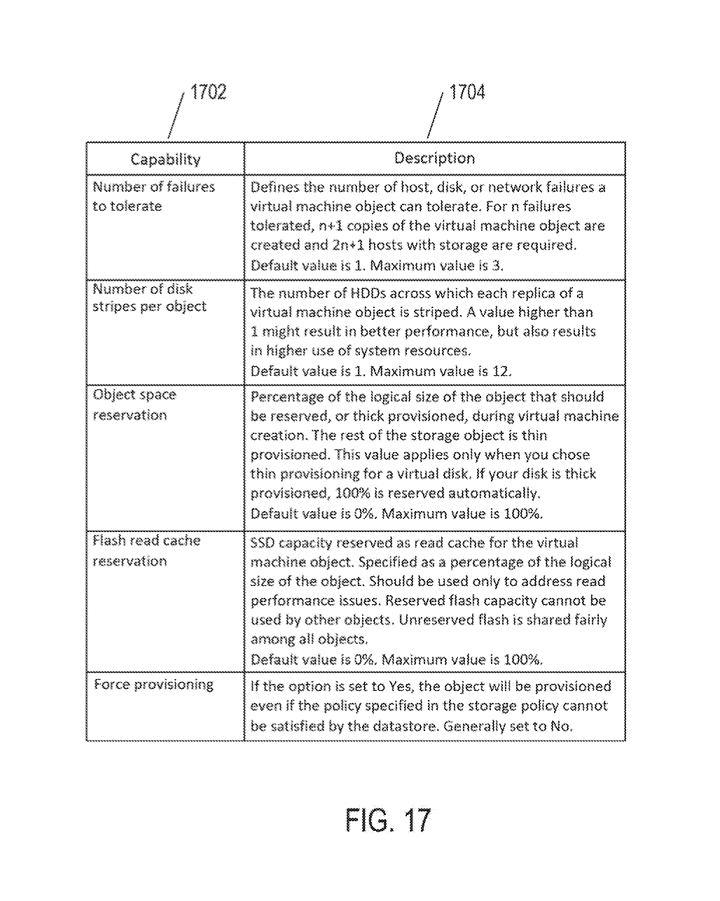

The method described below with reference to FIGS. 18-23 may be stored as machine-readable instructions of the computer readable medium and executed using the computer system described above with reference to FIG. 1. FIG. 18 shows a flow-control diagram of a method to determine virtual storage cost in a virtual data center. In block 1801, a routine “calculate total virtual storage cost” is calculate the virtual storage cost of VDC running in a cloud-computing facility. In block 1802, a routine “calculate HDD cost rate” is called to calculate the HDD cost rate of HDDs of the server computers and mass-storage devices of the cloud-computing facility. In block 1803, a routine “calculate SSD cost rate” is called to calculate the SSD cost rate of SSDs of the server computers and mass-storage devices of the cloud-computing facility. In block 1804, a routine “calculate cost of each VD of the virtual disk storage” is called to calculate the cost of each VD formed in the virtual disk storage of the virtual storage. In block 1805, a routine “calculate virtual storage cost of each VM” is called to calculate the virtual storage cost of each VM of the VDC.

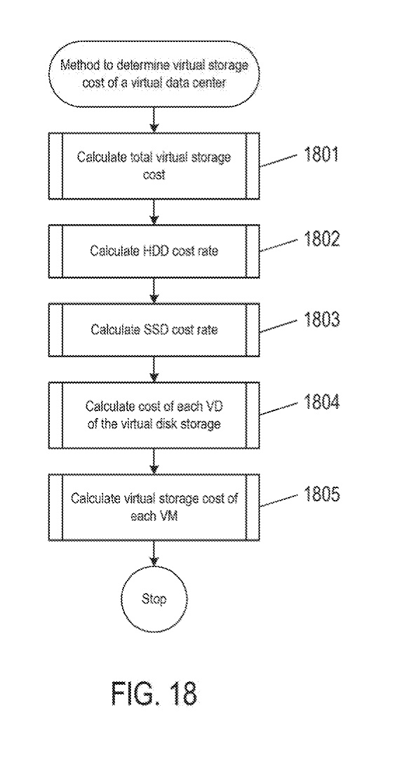

FIG. 19 shows a flow-control diagram of the routine “calculate total virtual storage cost” called in block 1801 of FIG. 18. In block 1901, the cost of HDDs over duration of a period of time are calculated according to Equation (7). In block 1902, the cost the SSDs over the duration of the period of time are calculated according to Equation (8). In block 1903, network cost is calculated over the duration of the period of time according to Equation (9). In block 1904, the license cost is calculated over the duration of the period according to Equation (10). In block 1905, labor cost, maintenance cost, and facilities cost are retrieved from the IT customer's expense reports. In block 1906, a total virtual storage cost is calculated as described above according to Equation (11).

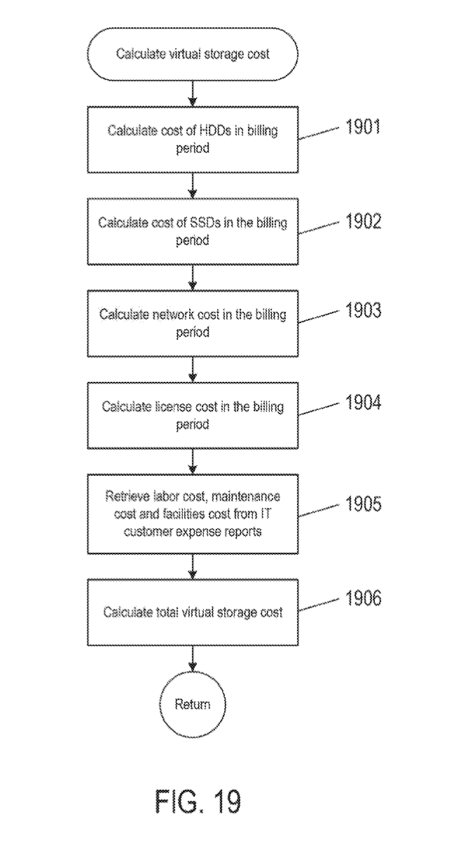

FIG. 20 shows a flow-control diagram of the routine “calculate HDD cost rate” called in block 1802 of FIG. 18. In block 2001, total cost of HDDs and total cost of SSDs are calculated as described above with reference to Equations (1) and (2). In block 2002, a fully loaded HDD cost is calculated for the HDDs in the cloud-computing facility used to form the virtual disk storage according to Equation (13). In block 2003, a total storage capacity of the HDDs of the cloud-computing facility are calculated according to Equation (15). In block 2004, an HDD cost rate for the HDDs of the cloud-computing facility is calculated according to Equation (17).

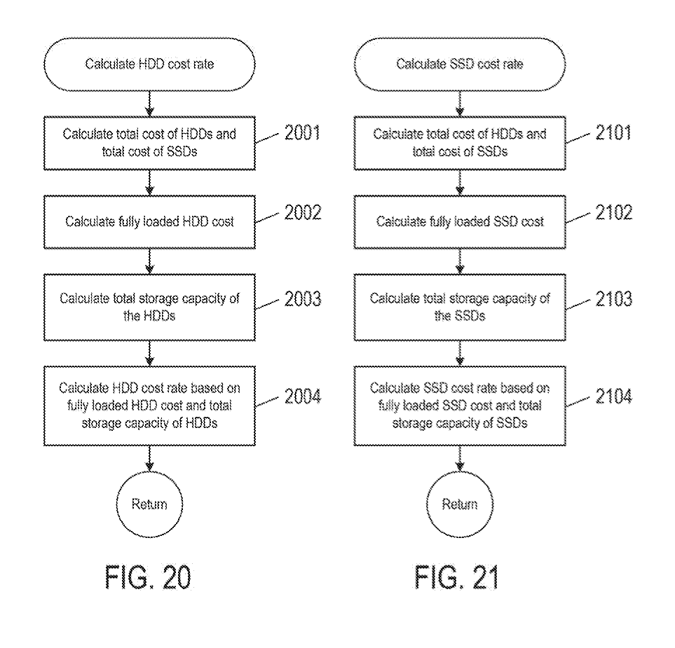

FIG. 21 shows a flow-control diagram of the routine “calculate SSD cost rate” called in block 1803 of FIG. 18. In block 2101, total cost of HDDs and total cost of SSDs are calculated as described above with reference to Equations (1) and (2). In block 2102, a fully loaded SSD cost is calculated for the SSDs of the cloud-computing facility used to form the virtual cache storage according to Equation (14). In block 2103, a total storage capacity of the SSDs of the cloud-computing facility are calculated according to Equation (16). In block 2104, an SSD cost rate for the SSDs of the cloud-computing facility is calculated according to Equation (18).

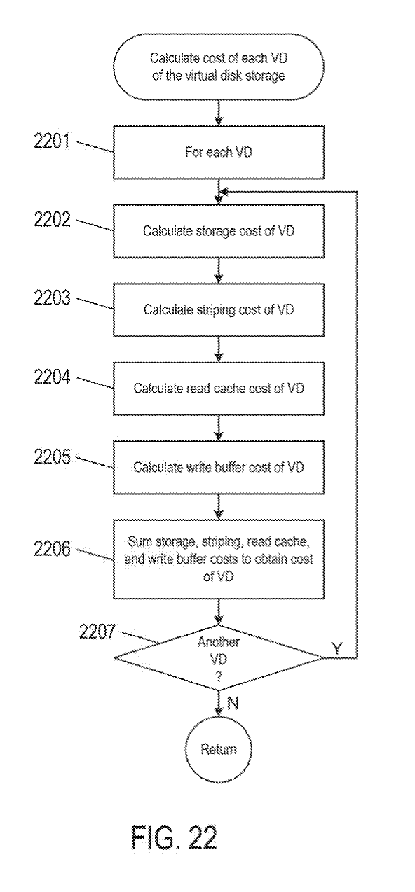

FIG. 22 shows a flow-control diagram of the routine “calculate cost of each VD of the virtual disk storage” called in block 1804 of FIG. 18. A loop beginning with block 2201 repeats the operations represented by blocks 2202-2206 for each VD formed in the virtual disk storage of the virtual storage. In block 2202, a storage cost of a VD is calculated over the duration of the period according to Equation (19). In block 2203, a striping cost of the VD is calculated over the duration of the period according to Equation (20). In block 2204, a read cache cost is calculated for the VD according to Equations (24), (26) and (27). In block 2205, a write buffer cost of the VD is calculated according to Equations (25) and (28). In block 2206, a cost of the VD is calculated as a sum of the storage, striping, read cache, and write buffer costs calculated in blocks 2202-2205 and stored in a computer readable medium. In decision block 2207, the operations represented by blocks 2202-2205 are repeated for another VD of the virtual disk storage.

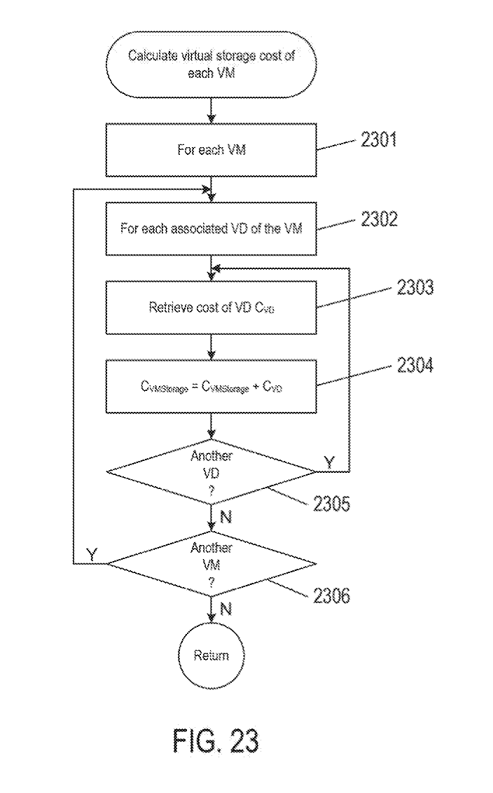

FIG. 23 shows a flow-control diagram of the routine “calculate virtual storage cost of each VM” called in block 1805 of FIG. 18. A loop beginning with block 2301 repeats the operations represented by blocks 2302-2304 for each VM of the VDC. A loop beginning with block 2302 repeats the operations represented by blocks 2303-2304 for each of the one or more VDs of the VM. In block 2303, the cost of the VD calculated for the VD in block 2206 of FIG. 2206 is retrieved from the computer readable medium. In block 2304, a virtual storage cost of the VM is calculated as a sum of the cost of VDs associated with the VM according to Equation (30). In decision block 2305, the operations represented by blocks 2303 and 2304 are repeated for another VD of the VM. In decision block 2306, the operations represented by blocks 2302-2305 are repeated for another VM of the VDC.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method to determine cost of virtual storage of a virtual datacenter created in a cloud-computing facility, the method comprising:
calculating a total virtual storage cost based on depreciation cost of hard disk drives (“HDDs”) and solid state drives (“SSDs”), licensing costs, labor costs, maintenance costs, and facility costs;
calculating an HDD cost rate based on the total virtual storage cost and on depreciation costs of the HDDs and the SSDs;
calculating an SSD cost rate based on based on the total virtual storage cost and on depreciation costs of the HDDs and the SSDs;
calculating a cost of each virtual disk (“VD”) of the virtual storage based on virtual storage policy parameters, the HDD cost rate, and the SSD cost rate; and
calculating virtual storage cost of the VM of the virtual datacenter as a sum of the cost of one or more VDs associated with each VM.

2. The method of claim 1, further comprises:
calculating a depreciation value of the HDDs in each server computer and mass-storage device of the cloud-computing facility;
calculating a depreciation cost of the HDDs of the cloud-computing facility as a sum of depreciation value of the HDDs divided by a number of periods;
calculating a depreciation value of the SSDs in each server computer and mass-storage device of the cloud-computing facility;
calculating a depreciation cost of the SSDs of the cloud-computing facility as a sum of depreciation value of the SSDs divided by the number of periods; and
summing the depreciation cost of the HDDs and depreciation cost of the SSDs to generate the depreciation cost of HDDs and SSDs.

3. The method of claim 1, wherein calculating the HDD cost rate comprises:
summing costs of HDDs of server computers and mass-storage devices of the cloud-computing facility used to host the virtual datacenter to generate a total cost of HDDs;
summing costs of SSDs of server computers and mass-storage devices of the cloud-computing facility used to host the virtual datacenter to generate a total cost of SSDs;
calculating a fully loaded HDD cost of the HDDs of the cloud-computing facility based on the total virtual storage and a ratio of the total cost of HDDs to total cost of HDDs and SSDs;
determining storage capacity of the HDDs of each server computer and mass-storage device of the cloud-computing facility;
calculating a total storage capacity of the HDDs as a sum of the storage capacity of the HDDs of each server computer and mass-storage device; and
dividing the fully loaded HDD cost by the total storage capacity of the HDDs to generate the HDD cost rate.

4. The method of claim 1, wherein calculating the SSD cost rate comprises
summing costs of HDDs of server computers and mass-storage devices of the cloud-computing facility used to host the virtual datacenter to generate a total cost of HDDs;
summing costs of SSDs of server computers and mass-storage devices of the cloud-computing facility used to host the virtual datacenter to generate a total cost of SSDs;
calculating a fully loaded SSD cost of the SSDs of the cloud-computing facility based on the total virtual storage and a ratio of the total cost of SSDs to total cost of HDDs and SSDs;
determining storage capacity of the SSDs of each server computer and mass-storage device of the cloud-computing facility;
calculating a total storage capacity of the SSDs as a sum of the storage capacity of the SSDs of each server computer and mass-storage device; and
dividing the fully loaded SSD cost by the total storage capacity of the SSDs to generate the SSD cost rate.

5. The method of claim 1, wherein calculating the cost of each VD comprises
calculating a storage cost of the VD based on used capacity of the VD and the HDD cost rate;
calculating a disk striping cost of the VD based on a unit cost rate per stripe and total number of stripes across the VDs of a virtual disk storage of the virtual storage;
calculating a read cache cost of the VD based on a read cache capacity of virtual cache storage of the virtual storage, read cache capacity of the virtual cache storage reserved for the VD, read rate of the VD, and the SSD cost rate;
calculating a write buffer cost of the VD based on a write buffer capacity of the virtual cache storage, write rate of the VD, and the SSD cost rate; and
summing the storage cost, the disk striping cost, the read cache cost, and the write buffer cost to generate the cost of the VD.

6. The method of claim 5, further comprising:
determining a total number of stripes across the VDs of the virtual disk storage as sum of stripe counts of the VDs;
calculate depreciation values of Ethernet cards of the each server computer and mass-storage device of the cloud-computing facility;
calculate depreciation values of network devices of the of the cloud-computing facility;
calculating a depreciation cost of the network of the cloud-computing facility as a sum of the depreciation values of the Ethernet cards and depreciation values of network devices divided by the number of periods; and
dividing the total number of stripes by the depreciation cost of the network to generate the unit cost rate per stripe.

7. A system to determine cost of virtual storage of a virtual datacenter created in a cloud-computing facility, the system comprising:
one or more processors;
one or more data-storage devices; and
machine-readable instructions stored in the one or more data-storage devices that when executed using the one or more processors controls the system to carry out
calculating a total virtual storage cost based on depreciation cost of hard disk drives (“HDDs”) and solid state drives (“SSDs”), licensing costs, labor costs, maintenance costs, and facility costs;
calculating an HDD cost rate based on the total virtual storage cost and on depreciation costs of the HDDs and the SSDs;
calculating an SSD cost rate based on based on the total virtual storage cost and on depreciation costs of the HDDs and the SSDs;
calculating a cost of each virtual disk (“VD”) of the virtual storage based on virtual storage policy parameters, the HDD cost rate, and the SSD cost rate; and
calculating virtual storage cost of the VM of the virtual datacenter as a sum of the cost of one or more VDs associated with each VM.

8. The system of claim 7, further comprises:
calculating a depreciation value of the HDDs in each server computer and mass-storage device of the cloud-computing facility;
calculating a depreciation cost of the HDDs of the cloud-computing facility as a sum of depreciation value of the HDDs divided by a number of periods;
calculating a depreciation value of the SSDs in each server computer and mass-storage device of the cloud-computing facility;
calculating a depreciation cost of the SSDs of the cloud-computing facility as a sum of depreciation value of the SSDs divided by the number of periods; and
summing the depreciation cost of the HDDs and depreciation cost of the SSDs to generate the depreciation cost of HDDs and SSDs.

9. The system of claim 7, wherein calculating the HDD cost rate comprises
summing costs of HDDs of server computers and mass-storage devices of the cloud-computing facility used to host the virtual datacenter to generate a total cost of HDDs;
summing costs of SSDs of server computers and mass-storage devices of the cloud-computing facility used to host the virtual datacenter to generate a total cost of SSDs;
calculating a fully loaded HDD cost of the HDDs of the cloud-computing facility based on the total virtual storage and a ratio of the total cost of HDDs to total cost of HDDs and SSDs;
determining storage capacity of the HDDs of each server computer and mass-storage device of the cloud-computing facility;
calculating a total storage capacity of the HDDs as a sum of the storage capacity of the HDDs of each server computer and mass-storage device; and
dividing the fully loaded HDD cost by the total storage capacity of the HDDs to generate the HDD cost rate.

10. The system of claim 7, wherein calculating the SSD cost rate comprises
summing costs of HDDs of server computers and mass-storage devices of the cloud-computing facility used to host the virtual datacenter to generate a total cost of HDDs;
summing costs of SSDs of server computers and mass-storage devices of the cloud-computing facility used to host the virtual datacenter to generate a total cost of SSDs;
calculating a fully loaded SSD cost of the SSDs of the cloud-computing facility based on the total virtual storage and a ratio of the total cost of SSDs to total cost of HDDs and SSDs;
determining storage capacity of the SSDs of each server computer and mass-storage device of the cloud-computing facility;
calculating a total storage capacity of the SSDs as a sum of the storage capacity of the SSDs of each server computer and mass-storage device; and
dividing the fully loaded SSD cost by the total storage capacity of the SSDs to generate the SSD cost rate.

11. The system of claim 7, wherein calculating the cost of each VD comprises
calculating a storage cost of the VD based on used capacity of the VD and the HDD cost rate;
calculating a disk striping cost of the VD based on a unit cost rate per stripe and total number of stripes across the VDs of a virtual disk storage of the virtual storage;
calculating a read cache cost of the VD based on a read cache capacity of virtual cache storage of the virtual storage, read cache capacity of the virtual cache storage reserved for the VD, read rate of the VD, and the SSD cost rate;
calculating a write buffer cost of the VD based on a write buffer capacity of the virtual cache storage, write rate of the VD, and the SSD cost rate; and
summing the storage cost, the disk striping cost, the read cache cost, and the write buffer cost to generate the cost of the VD.

12. The system of claim 11, further comprising:
determining a total number of stripes across the VDs of the virtual disk storage as sum of stripe counts of the VDs;
calculate depreciation values of Ethernet cards of the each server computer and mass-storage device of the cloud-computing facility;
calculate depreciation values of network devices of the of the cloud-computing facility;
calculating a depreciation cost of the network of the cloud-computing facility as a sum of the depreciation values of the Ethernet cards and depreciation values of network devices divided by the number of periods; and
dividing the total number of stripes by the depreciation cost of the network to generate the unit cost rate per stripe.

13. A non-transitory computer-readable medium encoded with machine-readable instructions that implement a method carried out by one or more processors of a computer system to perform the operations of
calculating a total virtual storage cost based on depreciation cost of hard disk drives (“HDDs”) and solid state drives (“SSDs”), licensing costs, labor costs, maintenance costs, and facility costs;
calculating an HDD cost rate based on the total virtual storage cost and on depreciation costs of the HDDs and the SSDs;
calculating an SSD cost rate based on based on the total virtual storage cost and on depreciation costs of the HDDs and the SSDs;
calculating a cost of each virtual disk (“VD”) of the virtual storage based on virtual storage policy parameters, the HDD cost rate, and the SSD cost rate; and
calculating virtual storage cost of the VM of the virtual datacenter as a sum of the cost of one or more VDs associated with each VM.

14. The medium of claim 13, further comprises:
calculating a depreciation value of the HDDs in each server computer and mass-storage device of the cloud-computing facility;
calculating a depreciation cost of the HDDs of the cloud-computing facility as a sum of depreciation value of the HDDs divided by a number of periods;
calculating a depreciation value of the SSDs in each server computer and mass-storage device of the cloud-computing facility;
calculating a depreciation cost of the SSDs of the cloud-computing facility as a sum of depreciation value of the SSDs divided by the number of periods; and
summing the depreciation cost of the HDDs and depreciation cost of the SSDs to generate the depreciation cost of HDDs and SSDs.

15. The medium of claim 13, wherein calculating the HDD cost rate comprises
summing costs of HDDs of server computers and mass-storage devices of the cloud-computing facility used to host the virtual datacenter to generate a total cost of HDDs;
summing costs of SSDs of server computers and mass-storage devices of the cloud-computing facility used to host the virtual datacenter to generate a total cost of SSDs;
calculating a fully loaded HDD cost of the HDDs of the cloud-computing facility based on the total virtual storage and a ratio of the total cost of HDDs to total cost of HDDs and SSDs;
determining storage capacity of the HDDs of each server computer and mass-storage device of the cloud-computing facility;
calculating a total storage capacity of the HDDs as a sum of the storage capacity of the HDDs of each server computer and mass-storage device; and
dividing the fully loaded HDD cost by the total storage capacity of the HDDs to generate the HDD cost rate.

16. The medium of claim 13, wherein calculating the SSD cost rate comprises
summing costs of HDDs of server computers and mass-storage devices of the cloud-computing facility used to host the virtual datacenter to generate a total cost of HDDs;
summing costs of SSDs of server computers and mass-storage devices of the cloud-computing facility used to host the virtual datacenter to generate a total cost of SSDs;
calculating a fully loaded SSD cost of the SSDs of the cloud-computing facility based on the total virtual storage and a ratio of the total cost of SSDs to total cost of HDDs and SSDs;
determining storage capacity of the SSDs of each server computer and mass-storage device of the cloud-computing facility;
calculating a total storage capacity of the SSDs as a sum of the storage capacity of the SSDs of each server computer and mass-storage device; and
dividing the fully loaded SSD cost by the total storage capacity of the SSDs to generate the SSD cost rate.

17. The medium of claim 13, wherein calculating the cost of each VD comprises
calculating a storage cost of the VD based on used capacity of the VD and the HDD cost rate;
calculating a disk striping cost of the VD based on a unit cost rate per stripe and total number of stripes across the VDs of a virtual disk storage of the virtual storage;
calculating a read cache cost of the VD based on a read cache capacity of virtual cache storage of the virtual storage, read cache capacity of the virtual cache storage reserved for the VD, read rate of the VD, and the SSD cost rate;
calculating a write buffer cost of the VD based on a write buffer capacity of the virtual cache storage, write rate of the VD, and the SSD cost rate; and
summing the storage cost, the disk striping cost, the read cache cost, and the write buffer cost to generate the cost of the VD.

18. The medium of claim 17, further comprising:
determining a total number of stripes across the VDs of the virtual disk storage as sum of stripe counts of the VDs;
calculate depreciation values of Ethernet cards of the each server computer and mass-storage device of the cloud-computing facility;
calculate depreciation values of network devices of the of the cloud-computing facility;
calculating a depreciation cost of the network of the cloud-computing facility as a sum of the depreciation values of the Ethernet cards and depreciation values of network devices divided by the number of periods; and
dividing the total number of stripes by the depreciation cost of the network to generate the unit cost rate per stripe.
